(19) United States
(12) Patent Application Publication
(10) Pub. No.: US 2008/0169403 A1
(43) Pub. Date: Jul. 17, 2008

(54) Audio Visual System

(75) Inventor: Glen Rooney, Victoria (AU)

Correspondence Address: BROOKS KUSHMAN P.C., 1000 TOWN CENTER, TWENTY-SECOND FLOOR, SOUTHFIELD, MI, 48075, US

(73) Assignee: CINEWARE PTY LTD, Victoria (AU)

(21) Appl. No.: 11/994,859

(22) PCT Filed: Jul. 5, 2006
(86) PCT No.: PCT/AU2006/000946

§ 371 Date: Jan. 7, 2008

(30) Foreign Application Priority Data
Jul. 5, 2005 (AU) 2005903576

(51) Int. Cl. B65H 49/22; G03B 21/56; G09F 19/18

(52) U.S. Cl. 248/343; 248/342; 242/129

(57) ABSTRACT

A projection system comprising: a screen and a projector spaced from the screen to project an image onto the screen, the screen and projector being suspended respectively from housings located in or on the ceiling or a wall of the room; each housing supporting an axially extending rod that supports a plurality of flexible suspension lines that are connected to an upper surface of the screen or a mount for a projector; and means to rotate each rod whereby the screen and projector can be lowered into an operative position or the lines can be wound onto the rods to lift the screen or projector into a stored position.

### INVENTION

This invention relates to audio visual systems and particularly to a positioning and concealment system particularly for use in the deployment and concealment of audio-visual equipment in home theatre, family, rumpus, common household areas and public areas like auditoriums or in a commercial environment. The invention also relates to a suspension system for use with audio visual systems.

### BACKGROUND OF THE INVENTION

Front projection systems provide pictures of proportions 90 inches diagonal and above. Many consider this size and above to be the true cinematic experience. However, for many a large front or rear screen and a projector is a combination that is too obtrusive, bulky and cumbersome to implement. Front projectors are usually positioned in the living space of the room thus introducing the issues with signal and power cabling. Front projection screens have to be usually deployed to a very large clear wall whether they are fixed, motorised or manual pull down.

Rear projection systems although usually smaller in size, when built into a housing tend to be bulky and permanent. Again for many this solution is considered to be too obtrusive, bulky and cumbersome.

Most front projector screens are not readily deployable to a ceiling due to the limited drop of most screens, the height of most ceilings, and the requirement for a screen to be positioned at eye level of the viewer's seated position.

Projection screens that have a long drop made generally have problems with curling, rippling, look and behave like a large sail because of the substantial size and dimensions of material of the screen. Other mechanical methods are applied in some cases to try to correct these limitations such as complex and bulky tab tensioning systems that give the screen a hyperbolic shape with physical tabs every few inches around the sides of the screen.

A projector should be positioned relative to the screen usually directly above the top edge of the screen with the projector inverted. This provides the maximum number of lumens delivered to the screen and provides best sharpness and brightness with no keystoning. There has, in the past, been use of mechanical scissor type mechanisms or poles of varying lengths, which are bulky and permanent. The mechanical scissor type mechanisms are also bulky, will not fit in many smaller ceiling cavities or between ceiling joists, are limited by the number of scissors and therefore must be mechanically extended to provide longer drops. They are also very industrial in appearance and are not usually easily serviced or replaced from within the room.

Customers therefore have problems with deploying, mounting and positioning of the components required to provide quality front and rear projection solutions. It is these issues that have brought about the present invention.

### SUMMARY OF THE INVENTION

According to a first aspect of the present invention there is provided a projection system comprising a screen and a projector spaced from the screen to project an image onto the screen, the screen and projector being suspended respectively from housings located in or on the ceiling of the room, each housing supporting an axially extending rod that supports a plurality of flexible suspension lines that are connected to an upper surface of the screen or a mount for the projector, means to rotate each rod whereby the screen and projector can be lowered into new position or the lines can be wound onto the rods to lift the screen or projector into a stored position in the ceiling.

In accordance with a further aspect of the present invention there is provided a suspension system for a projector and screen comprising a plurality of flexible suspension lines connected between an axially rotatable support and part of the frame of the projector or screen, the lines being spaced apart to provide hanging support for the screen or projector at spaced positions on the screen or projector, and means to axially rotate the support to cause the lines to wind or unwind on the support thereby either raising or lowering of the screen or projector.

The support may be of square or circular cross section and is preferably self driven. Alternatively a separate drive means may be used to drive the support. In a preferred embodiment the support and drive means are part of the tubular motor.

In a preferred embodiment the suspension system is secured to the ceiling of a room with a support housed within an aperture in the ceiling. In a preferred embodiment the aperture in the ceiling is closed off by pivoting flap means.

In accordance with a still further aspect of the present invention there is provided a system for raising or lowering an article comprising support means positioned in an overhead position above the article, an arrangement of a plurality of flexible suspension lines interconnecting the article with the support means, the arrangement being such that when the article is in the suspended position the arrangement resists lateral deflection of the article; and means to rotate the support means to cause the lines to wind onto or off the support means to effect raising and lowering of the article.

Preferably the support means and means of rotation comprise a tubular motor.

The invention also relates to an image bordering or masking system particularly used for framing any projected image.

Over the years the standards for content like movies, regular TV programs and HDTV programs have been produced in different aspect ratios. For example normal TV is 4:3, High Def TV is 16:9, most quality DVDs are in CinemaScope that is 2.35:1 etc. But the projection devices can only natively display one aspect ratio, for example, normal TV's are 4:3, Plasma, LCD TVs and most home theatre projector screens are 16:9 or 4:3. This problem leads to consumer frustration caused by the black bars that appear at the top and bottom or either side of the screen. The problem is that these black bars for most devices and especially projectors are not black but are perceived as grey or much lighter than a true light absorbing black. This problem has a significant effect on the perceived contrast of the total image.

What is required is to provide a device for a projector screen with the ability to physically modify its aspect ratio or bordering capability with dynamic masking that is compatible with most screen mechanisms and is cost effective. It is these issues that have brought about the current screen masking invention.

The invention also relates to a fixed projection screen system particularly used for providing a fixed screen on any flat surface, usually a wall. It also incorporates a dynamic image bordering and masking system.

Fixed projection screens are usually composed of a fixed frame with a partially flexible screen material stretched across it. The area required for a fixed screen is usually a wall space with at least the area of the screen available. The fixed frame and flexible material used mean that simple dynamic borders or masking is impractical.

Other approaches to fixed screens involve the preparation of the wall surface for projection followed by painting the wall with a reflective paint and then adhering a fixed border. However, this only provides bordering or masking of the image at a specific aspect ratio and dynamic removal of the screen is not an option.

A simpler easier alternative to apply and remove a screen that is more cost effective is required that can provide dynamic bordering/masking and immediate and simple removal of a screen, if desired. It is these issues that have brought about the present fixed screen and masking invention.

There are numerous numbers of suppliers of projectors for the home or business theatres and there can be at any one time, hundreds of models in the marketplace for different categories of markets. Mounting facilities and configurations for projectors vary greatly and the traditional approach is to create a mounting bracket for each make and model. A better solution is to provide a universal mounting facility.

By their nature universal mounting solutions provide mechanisms that are bulky and unsightly where flexibility is exchanged for bulk. What is required is a universal mounting system that delivers the smallest form and leaves most of the bulk in the mounting kit rather than in the room. It is these issues that have brought about the universal mounting invention.

The invention also relates to a ceiling mounting kit used for mounting a projector to the ceiling. Many ceilings are too high for projectors to work at their optimum and therefore must be lowered from the ceiling to their preferred operating position. This is typically achieved by mounting poles. Most of these are complex, do not manage unsightly cables and sacrifice flexibility for bulk. In many cases they are fixed directly to the ceiling by a fixing plate, which makes the mount and the cables more bulky and obvious in a room. Most involve cable management tubes which makes discrete cable management more difficult. What is needed is a more comprehensive mounting system. It is these issues that have brought about the present projector ceiling mounting invention.

### DESCRIPTION OF THE DRAWINGS

Embodiments of the present inventions will now be described by way of example with reference to the accompanying drawings:

FIG. 1A is a perspective illustration of a suspended screen in an operating position;

FIG. 1B is a detailed view of the crossing of suspension lines for the screen;

FIG. 1C is a closer perspective view of an anti-ridging and support mechanism of the screen;

FIG. 1D is a cross-sectional view of an anti-ridging mechanism of the screen;

FIG. 1E is a detailed perspective view of the wire-locking strip;

FIGS. 2A, 2B and 2C are cross-sectional views showing the screen as it is wound up onto an overhead support;

FIG. 2D is a detailed cross-sectional view of the suspension of the screen when the screen is supported from a top rail;

FIGS. 3A, 3B and 3C are cross-sectional views showing the screen as it is wound up onto an overhead support;

FIG. 3D is a detailed cross-sectional view of the suspension of the screen;

FIG. 3E is a cross-sectional view showing the screen fully wound onto the overhead support;

FIG. 3F is a detailed cross-sectional view of another embodiment of a suspension of the screen;

FIG. 3G is a detailed cross-sectional view of yet another embodiment of a suspension of the screen;

FIG. 4A is a front view of the screen suspension system;

FIG. 4B is a front view of a multi-wire suspension configuration of the screen suspension system;

FIG. 4C is a front view of a continuous-wire suspension configuration of the screen suspension system;

FIG. 4D is a perspective view of one wire of the multi-wire suspension configuration;

FIG. 4E is a close up perspective view of a fastening loop;

FIG. 4F is a perspective view of a continuous-wire suspension component;

FIG. 4G is a front view of an example of multi-wired screen suspension system;

FIG. 4H is a close-up perspective view of the overhead support wire terminating fastening system;

FIG. 4I is a close-up perspective view of the screen top rail wire terminating fastening system;

FIG. 4J is a front overview of an example continuos-wire screen suspension system;

FIG. 4K is a close-up perspective view of the screen top rail continuous-wire fastening and locking system;

FIG. 4L is a close-up perspective view of the pass through device for a continuous-wire;

FIG. 5A is a perspective overview example of a suspension system with interaction points highlighted;

FIG. 5B is a detailed front illustration of a wire cross next to each other interaction point;

FIG. 5C is a detailed front illustration of the wrap over interaction point;

FIG. 5D is a detailed front illustration the wrap around interaction point;

FIG. 6A is a front view of the first example of the screen suspension system highlighting interaction point configuration;

FIG. 6B is a front view of the second example of the screen suspension system highlighting interaction point configuration;

FIG. 6C is a front view of the third example of the screen suspension system highlighting interaction point configuration;

FIG. 6D is a front view of the fourth example of the screen suspension system highlighting interaction point configuration;

FIG. 6E is a front view of the fifth example of the screen suspension system highlighting interaction point configuration;

FIG. 6F is a front view of the sixth example of the screen suspension system highlighting interaction point configuration;

FIG. 6G is a front view of an example of an inwardly angled screen suspension system with no interaction points;

FIG. 6H is a front view of an example of an outwardly angled screen suspension system with no interaction points;

FIG. 7A is an integrated perspective and cross-sectional view of the screen support roller and screen top rail that form the winding management and anti-ridging component of the screen system;

FIGS. 7B, 9C and 9D are integrated perspective and cross-sectional views of different examples of alternative forms of screen support roller and screen top rail configurations;

FIG. 8 is a perspective view of the projector system in the retracted position with a corner of the housings cut away;

FIG. 9 is a perspective view from the top of the projector support system external plenum housing with suspension mounting system;

FIG. 10 is a perspective view from the bottom of the projector support system external plenum housing with suspension mounting system;

FIG. 11 is a perspective view of the projector support system cartridge with the projector system fully contracted without the external plenum housing;

FIG. 12 is a cutaway perspective view of the projector support system with the projector in a suspended position;

FIG. 13 is a perspective view of an adjustment collar;

FIG. 14 is a perspective view of a cut through of a spiral cable management mechanism;

FIG. 15 is a cutaway perspective view of projector support system with projector carriage in the contracted position;

FIG. 16 is a perspective view of the projector carriage in the retracted position with the spiral cable management mechanism;

FIG. 17 is a cutaway perspective view of the projector support system with the projector in a suspended position in a totally wireless or cable less embodiment;

FIG. 18 is a perspective view of a HDTV signal transmitter and receiver;

FIG. 19 is a perspective view of a power docking station;

FIGS. 20 A1 and A2 are a perspective and a top view of the preferred embodiment of flexible suspension lines;

FIGS. 20 B1 and B2 are a perspective and a top view of an alternate arrangement of suspension lines;

FIGS. 20 C1 and C2 are a perspective and a top view of an alternate arrangement of suspension lines;

FIGS. 20 D1 and D2 are a perspective and a top view of an alternate arrangement of suspension lines;

FIGS. 20 E1 and E2 are a perspective and a top view of an alternate arrangement of suspension lines;

FIGS. 20 F1 and F2 are a perspective and a top view of an alternate arrangement of suspension lines;

FIGS. 20 G1 and G2 are a perspective and a top view of an alternate arrangement of suspension lines;

FIGS. 20 H1 and H2 are a perspective and a top view of an alternate arrangement of suspension lines;

FIGS. 20 I1 and I2 are a perspective and a top view of an alternate arrangement of suspension lines;

FIG. 21 is a perspective view from the bottom of the projector carriage in the contracted position with the bottom closure plate removed;

FIG. 22A is a perspective illustration of a suspended screen in an operating position with screen masks;

FIG. 22B is a cross-sectional illustration of a magnetic screen mask and examples of magnetically attracted materials on screen;

FIGS. 22B1, 22B2, 5B3 and 22B4 are cross-sectional illustrations of screen treatments;

FIG. 23A is a perspective illustration of a suspended screen in an operating position with screen masks applied;

FIG. 23B is a cross-sectional illustration of ferrous screen mask with application examples of magnetic materials;

FIGS. 23B1 and 23B2 are cross-sectional illustrations of screen treatments;

FIG. 23C is a perspective illustration of a suspended screen in an operative position with screen masks applied;

FIG. 23D is a cross-sectional illustration of static electricity screen mask;

FIGS. 24A1 and 24A2 is a perspective illustration of magnetic screen masks applied to a wall;

FIG. 24B is a cross-sectional illustration of a magnetic screen mask and magnetic attracting wall examples;

FIGS. 24B1 and 24B2 are cross-sectional illustrations examples of wall treatments facilitating dynamic attachment;

FIG. 24C is a perspective illustration of a ferrous screen mask applied to a wall;

FIG. 24D is a cross-sectional illustration of a ferrous magnetic screen mask and wall treatment to facilitate dynamic attachment;

FIG. 24E is a perspective illustration of a fixed screen broken down into components positioned in order a short distance from a wall;

FIG. 24F is a cross-sectional illustration of a fixed screen broken down into components;

FIG. 25 a perspective view of a fixed universal mount deployed in a ceiling;

FIG. 26 is a perspective view of the universal turret mount only;

FIG. 27 is an enlarged perspective view of the universal mount;

FIG. 28 is an enlarged expanded view of the arm assembly of the universal mount;

FIG. 29 is a perspective view of the adjustable suspension mount in an operating position;

FIG. 30 is a detailed view of the bottom plate eyelets;

FIG. 31 is a detailed view of the top plate eyelets;

FIG. 32 is a detailed view of fastening devices binding the two ends of the continuous wire;

FIG. 33 is a perspective view of an alternative embodiment of the adjustable suspension mount utilising an alternative form of eyelet;

FIG. 34 is a perspective view of an alternative embodiment of the adjustable suspension mount for long drops;

FIG. 35 is a perspective view of an alternative embodiment of the adjustable suspension mount for direct deployment to a ceiling;

FIG. 36 is a perspective illustration view of an alternative triangular embodiment of the suspension mount;

FIG. 37 is perspective view of an alternative embodiment of the suspension mount with an alternative threading pattern; and

FIG. 38 is a perspective view of the suspension mount with the universal mounting system.

### DESCRIPTION OF THE EMBODIMENTS

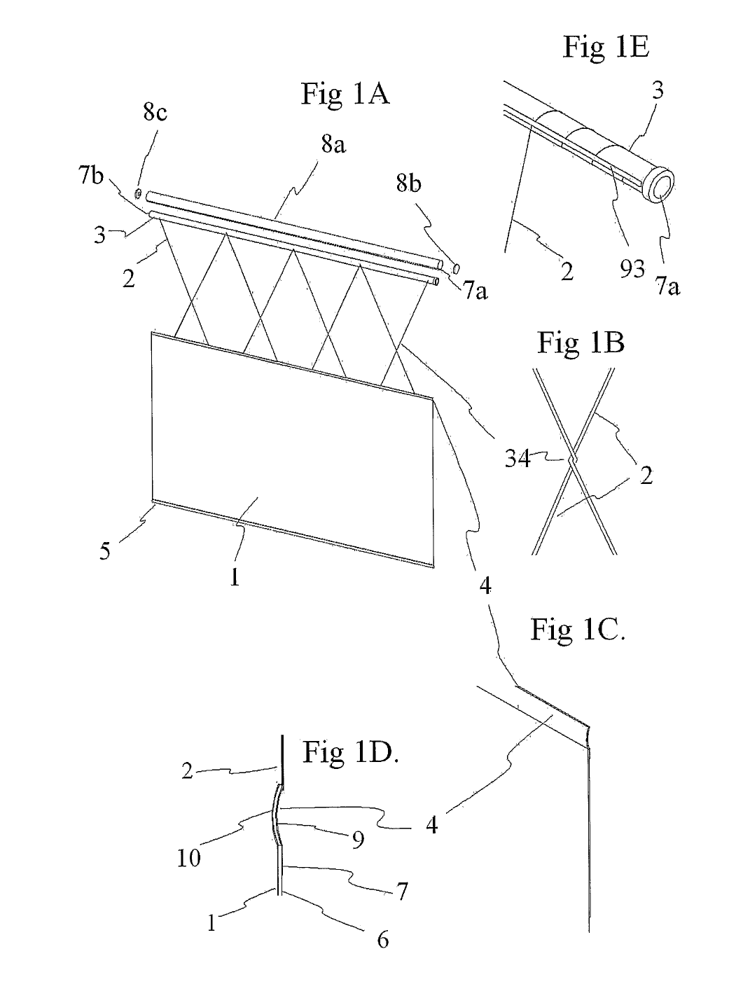

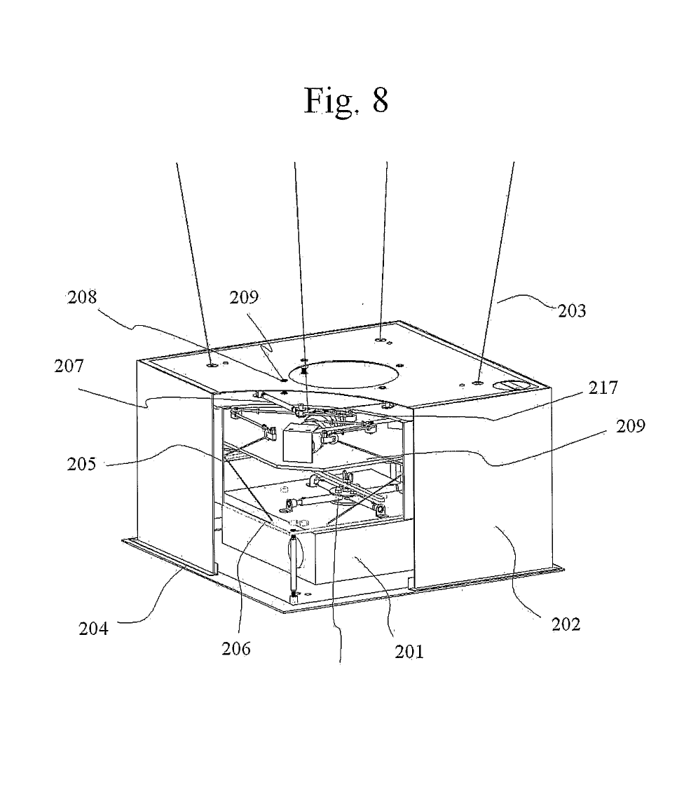

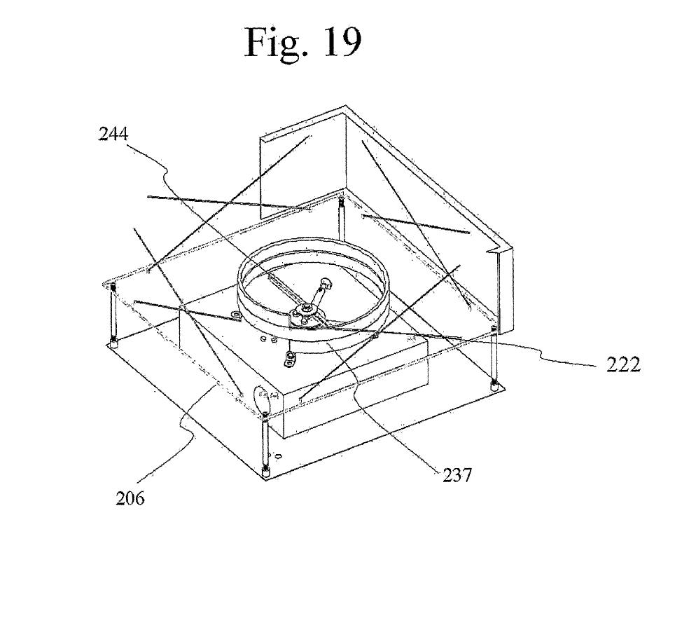

The vertical positioning and concealment system is essentially composed of a projector system and screen system. The screen system is described in FIGS. 1A to 7D and the projector system is described in FIGS. 8 through 21.

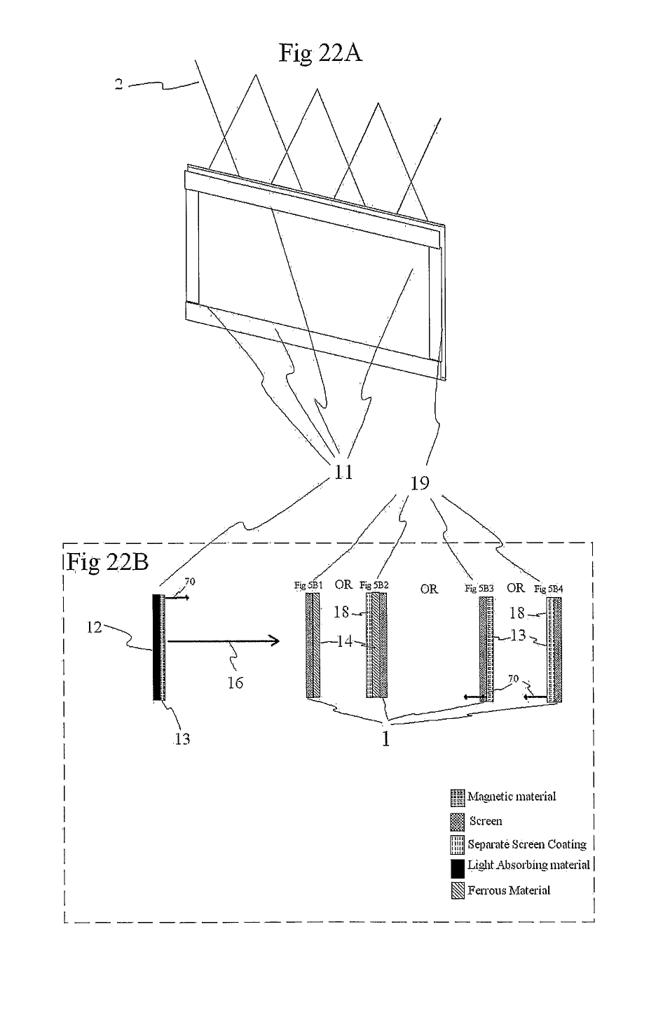

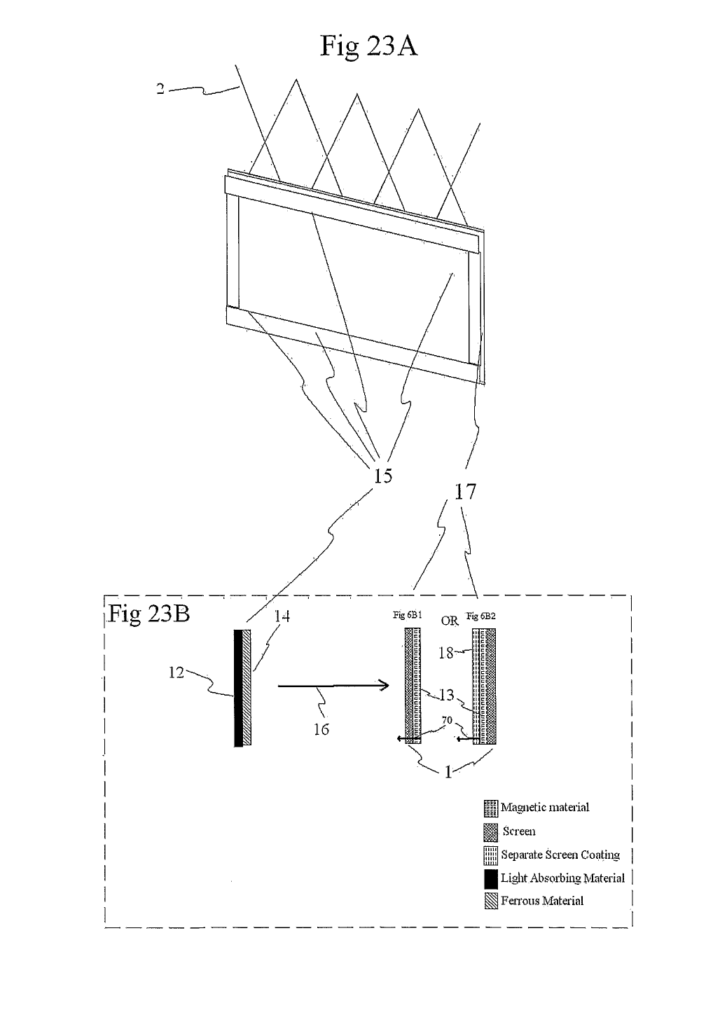

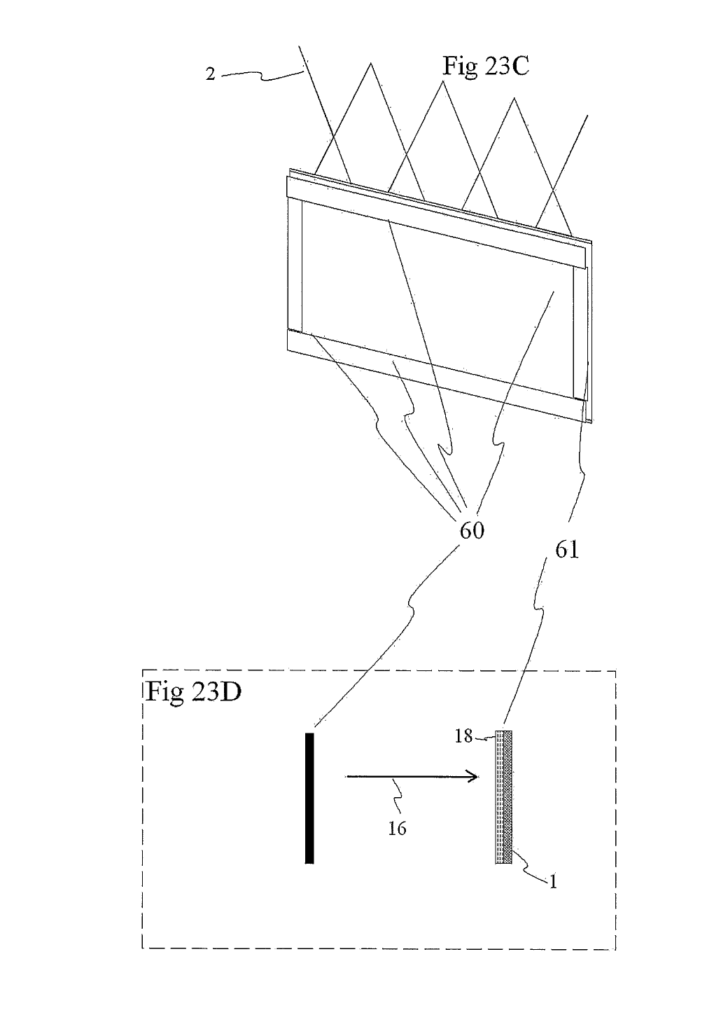

The image bordering or masking system is illustrated in the FIGS. 22A through 23C.

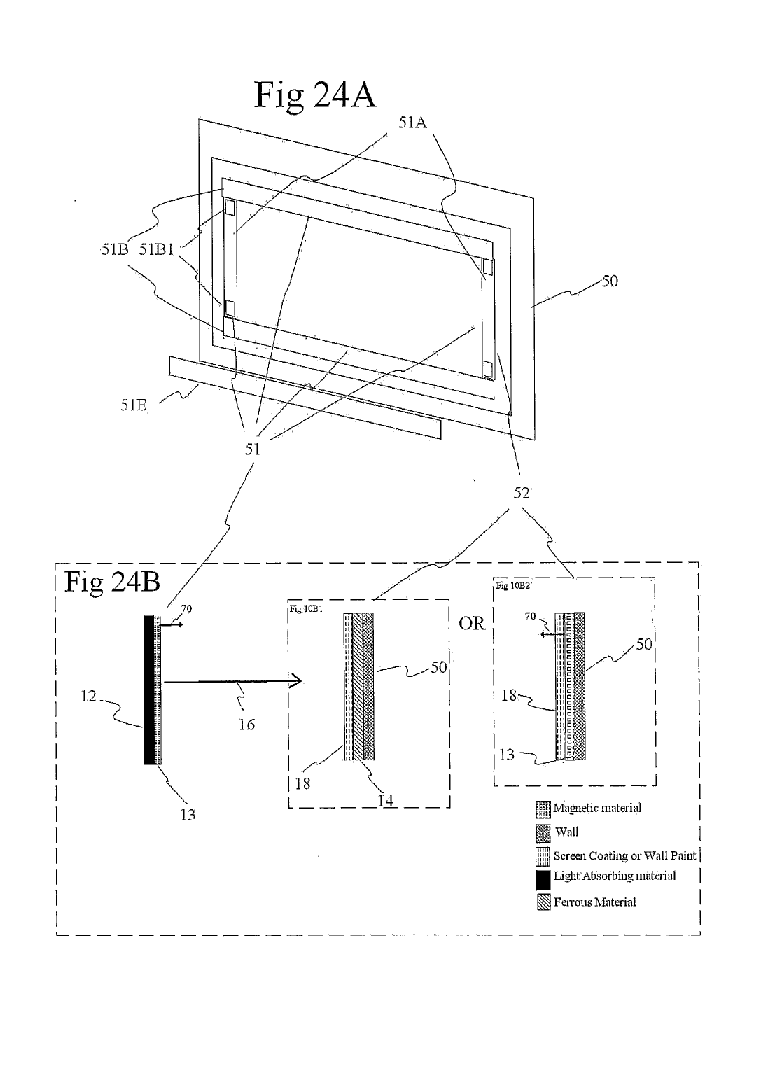

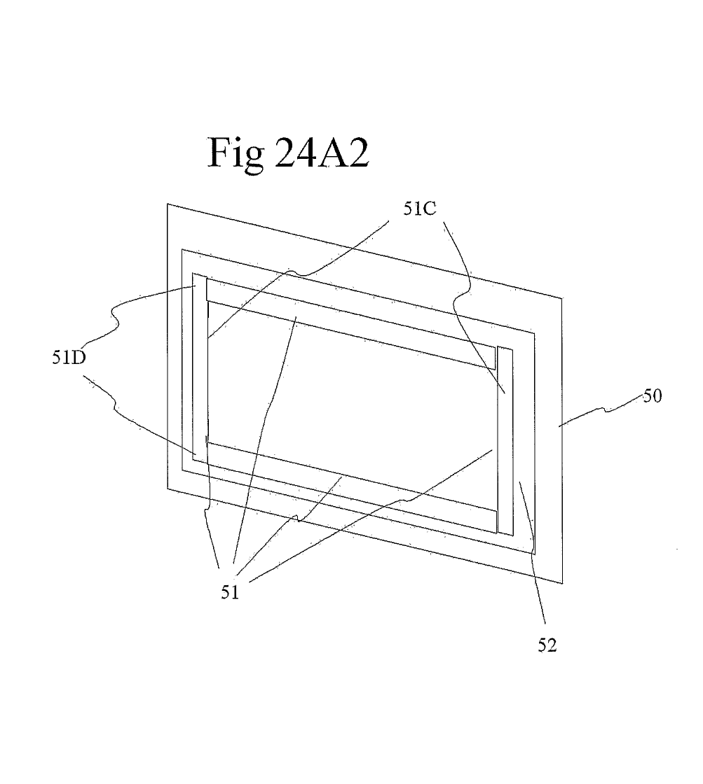

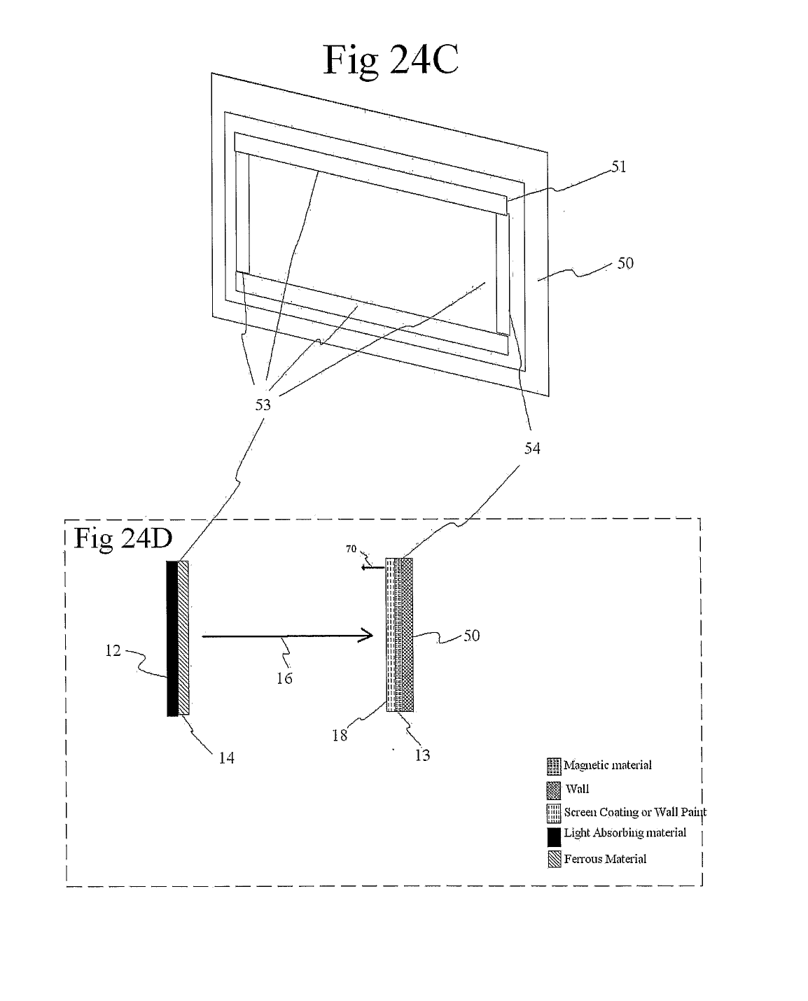

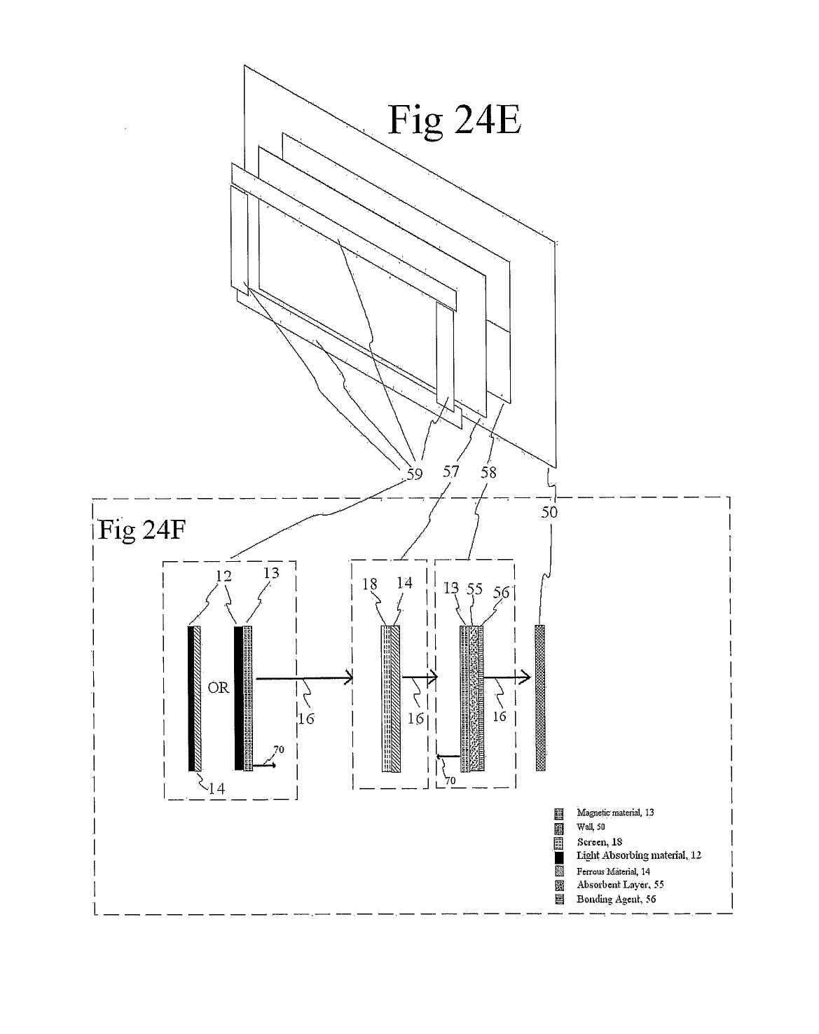

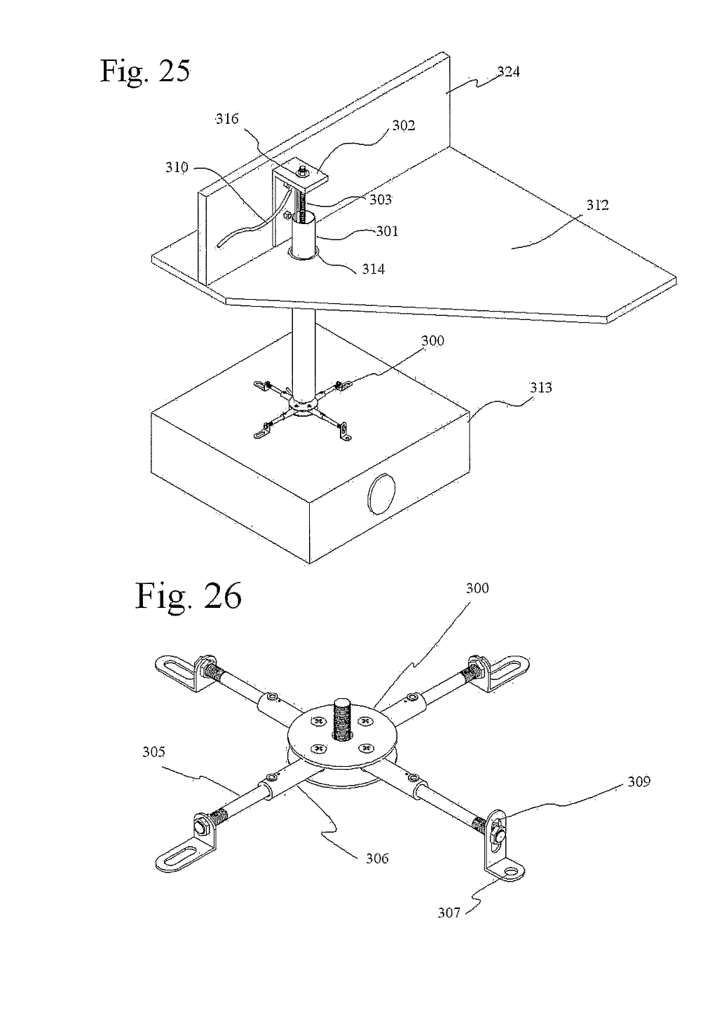

The fixed screen and masking system is illustrated in FIGS. 24A through 25E.

The universal mounting system and ceiling mounting system are illustrated in FIGS. 25 through 28.

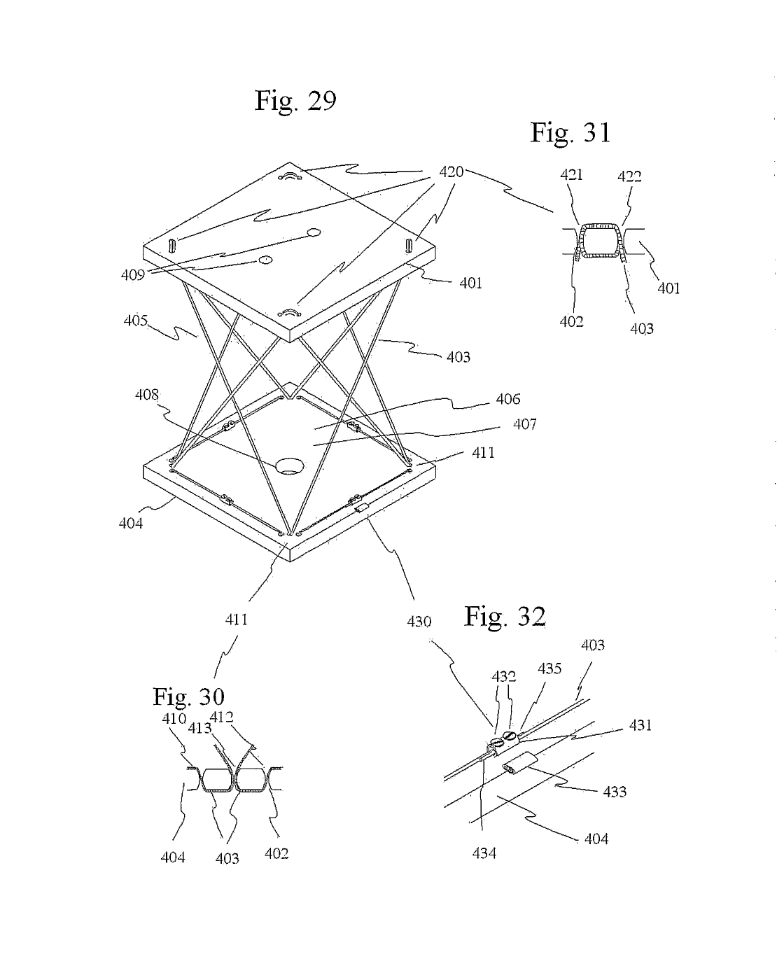

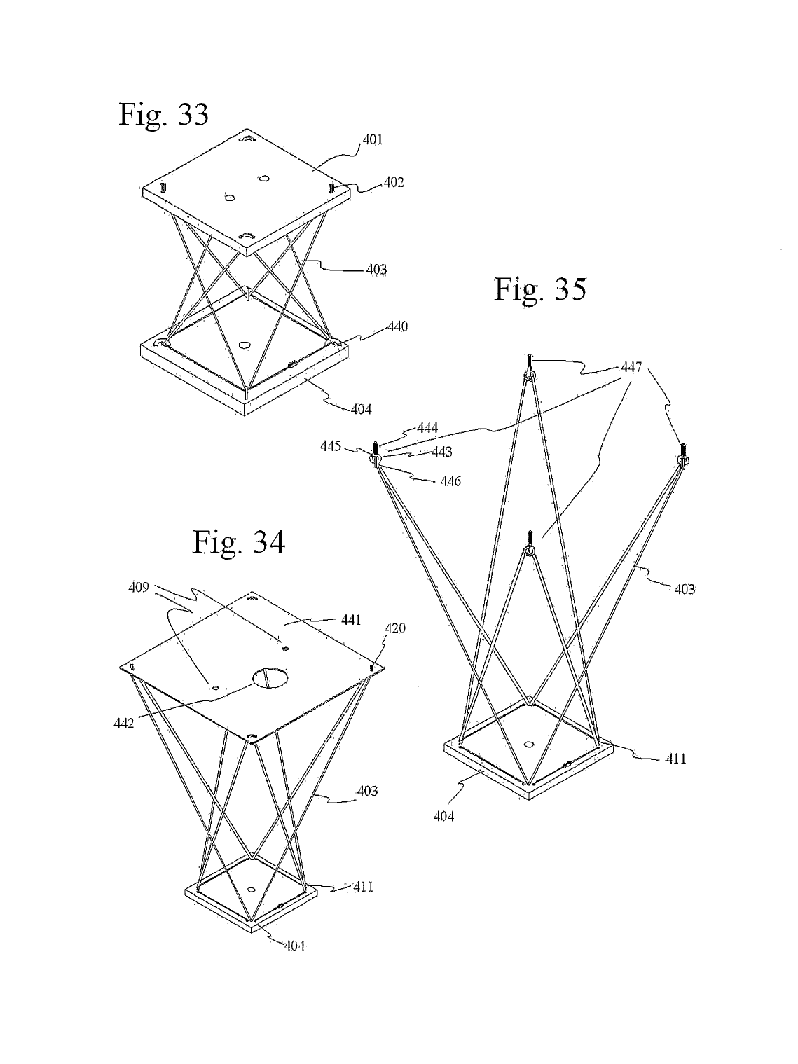

The adjustable suspension mount is illustrated in FIGS. 29 through 38.

The positioning of both the screen 1 and the projector 201 is carried out by use of flexible suspension lines which in the preferred embodiment are nylon coated wires or wires (screen system 2, 222) that extend from a rod or roller (screen system 3, projector system 210) that is mounted so that the suspension wires (projector screen system 2, projector system 222) can be wound onto the rod (screen system 3, projector system 210) to move either the screen 1 or the projector 210 to a stored position. In the preferred embodiment the rod is a tubular roller.

As shown in FIG. 1A the screen system assembly comprises a rectangular screen 1 composed of materials that can be rolled like but not limited to flexible vinyl, plastics, fabrics and films. The screen 1 has a top rail 4 and bottom rod or rail 5. The top rail is shown in more detail in FIGS. 1C and 1D. The top rail generally has or can assume the same curvature as the outer surface of the overhead support rod or roller 3. Screen 1 is generally fastened from the back over to the front surfaces of the rail. A rod or rail 5 is fastened to the bottom of the screen 1. The backside of the screen 1 below the top rail 4 is partially covered with a sheet of flexible foam or flexible fabric 6 the thickness of the top rail 4. The length of the foam sheet approximately matches the circumference of the roller less the top rail 4. The roller 3 has suspension lines 2 supporting the screen 1. The suspension lines can be composed of suspension wires 2 and are supported by the roller 3 along the length of the roller and support the top of the screen along its length via the top rail 4 as in the configuration shown in FIG. 1A. FIG. 1B shows an interacting tension adjustment point 34 formed by wrapping two adjacent wires around each other. FIG. 1D shows a cross section of the top rail 4 with wires 2 and screen 1 attached.

FIG. 1E shows a roller 3 and wires 2 in the usual deployed or operating position. The projector screen 1 would usually be deployed with some wire 2 still present on the roller because the desired drop height of the screen 1 will be obtained without unwinding all of the wires 2. Under some circumstances it is required that a wire-locking strip 93 is utilised. The locking strip is very thin running the length of the roller 3 and has an adhesive on the underside. The wire-locking strip 93 is applied after the final position of the screen is determined. It is applied just above where the wires leave the roller 3. It is left on for the duration of the life of the screen in that position. The wire-locking strip will prevent the wires moving from their natural position even when the screen 1 is severely tampered with.

It is understood that the suspension wires 2 may take many forms and can include multi-stranded wire as well as nylon, cotton or suitable yarns formed as a cable. In the preferred embodiment the wires are multi-stranded steel wire with a nylon coating.

The roller 3 at one end is fastened to a tubular motor 7a the and at the other a friction reduced rotational means 7b. The roller is housed in a tubular or rectangular housing 8 and capped at either end with caps 8a and 8b.

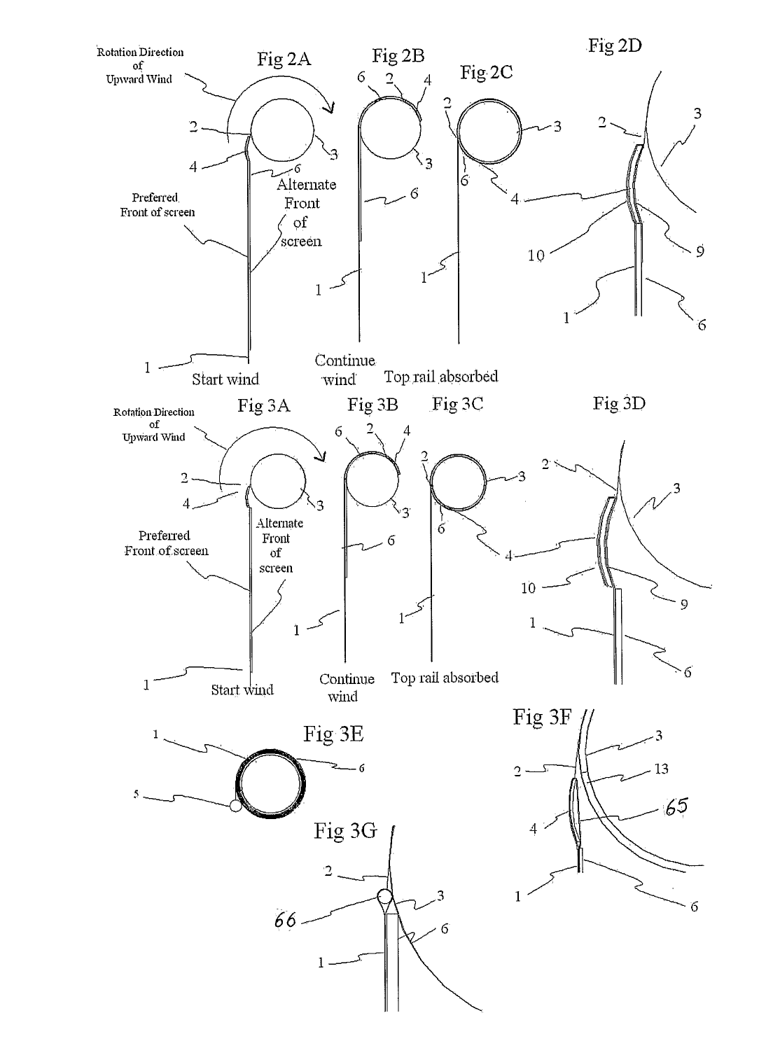

FIG. 2D more closely shows the suspension of the screen from the convex side of the top rail 10. FIG. 3D more closely shows the suspension of the screen from the concave side of the top rail 9.

It is understood that an alternative example of suspension of the screen 1 is the forming of an integrated top rail by pressing screen 1 between two top rails 4. Or the forming of a U-shaped top rail with either side of the U shaped pressed to either side of the screen 1. The top rail 4 still must also posses the same curvature as that of the roller 3. The thickness of the top rail 4 must be sufficient to facilitate perfect support of the screen 1 between the suspension wires when it is in the operating position. The flexible foam 6 under this example must still be present to absorb wires 2 and any impact from the thickness of the top rail 4.

FIGS. 2A 2B 2C and 3A 3B 3C describe the wind process for the screen 1. As shown in FIGS. 2A 2B and 2C the roller 3 rotates to cause the wires 2 and screen 1 to be wound onto the roller 3. The suspension wires 2 wrap around the roller 3 until top rail 4 and foam backing 6 first contact the edge of the roller 3 as shown in FIG. 2A. As the motor continues to wind the top rail 4, the foam backing 6 and screen 1 wraps around the roller 3 as shown in FIG. 2B until the position in FIG. 2C when the top rail 4 has been end to end absorbed by the layer of flexible foam 6 that now extends around the roller 3. The remainder of the screen 1 can then be wound up with a balanced wind without ridging or lumping until the screen 1 assumes the position in FIG. 3E in which the screen 1 is completely wrapped around the roller 3.

FIGS. 3A 3B and 3C shows the same winding process as FIGS. 2A 2B 2C except the screen 1 is suspended from the concave side 9 of the top rail 4, as shown in FIG. 3D.

FIG. 3F shows another alternative embodiment of the top rail 4. A pocket 65 is created for the top rail 4.

FIG. 3G also shows an alternative to a curved top rail 4 and instead uses a thin rod 66.

Depending on the suitability and rigidity of the screen material small panels may be placed on either side of the screen on the inward winding side which when wound will sufficiently support the screen to create an air space between the wind and the immediate preceding screen wind which will reduce any screen ridging that may occur.

FIG. 3F also shows the use of a magnetic layer 13 on the roller 3 where the magnetic layer holds the wires to the roller.

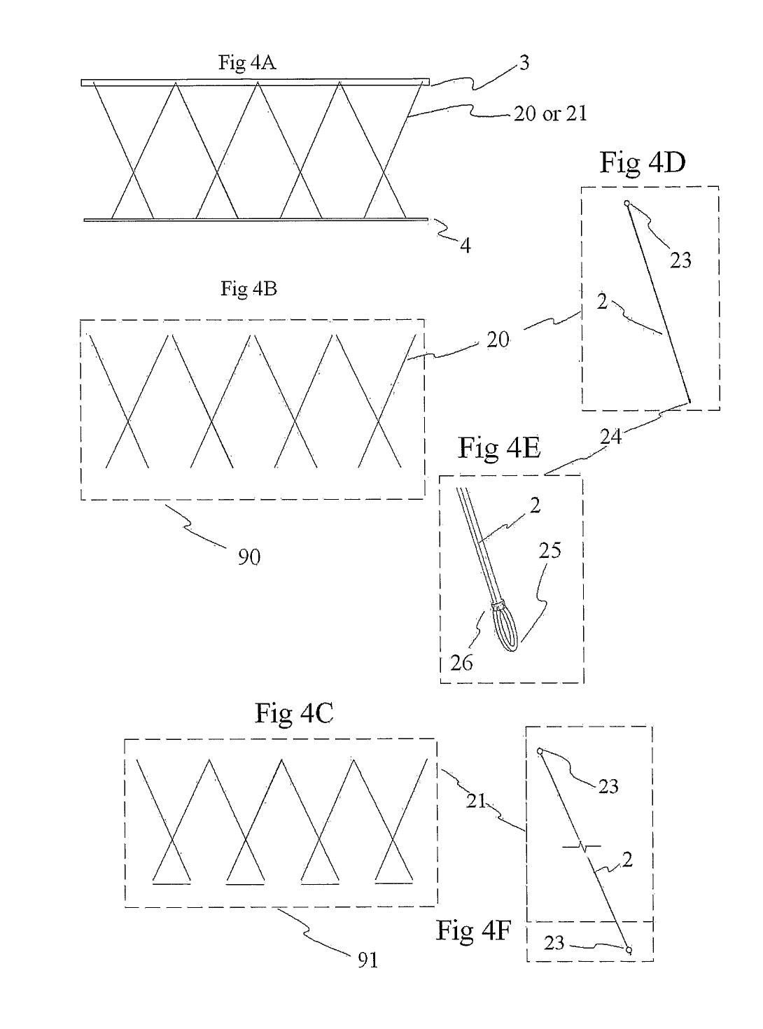

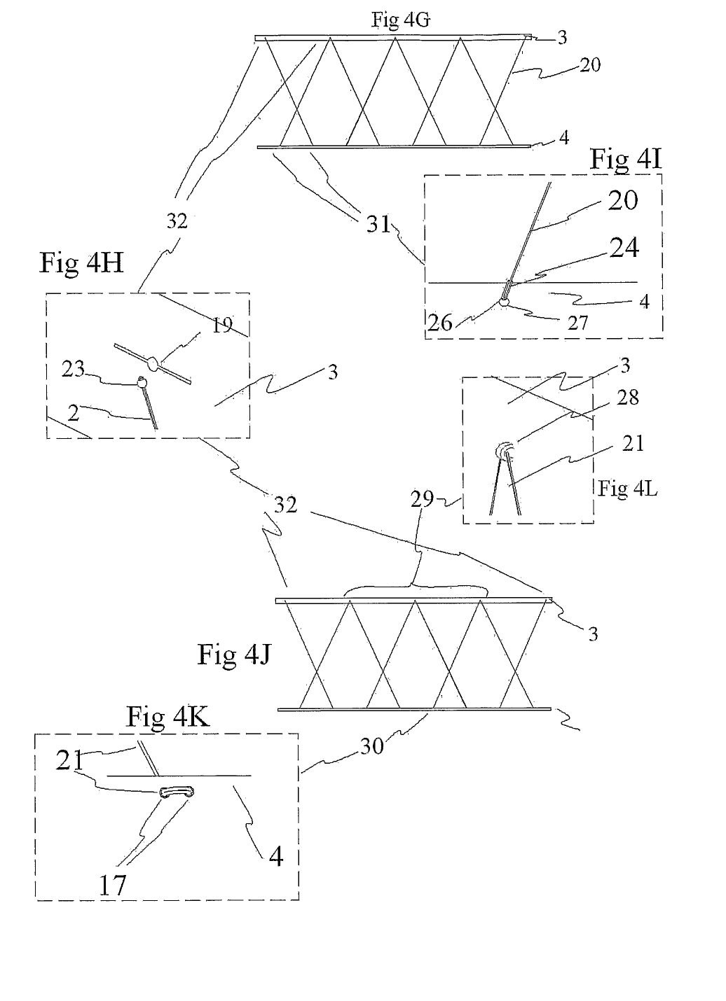

FIG. 4A shows the basic screen suspension system components in a deployed position. The roller 3 is connected to the top rail 4 by means described in FIGS. 4D and 4F. FIG. 4B shows an example of a multi-wire suspension configuration 90. Multi-wire suspension configurations 90 have from two to many multi-wire suspension components 20. Each multi-wire suspension component 20 is terminated at the roller 3 and top rail 4. Each multi-wire suspension component 20 is generally of consistent length.

FIG. 4D shows and example of a multi-wire suspension component 20 composed of a suspension wire 2 with a terminating bulb or bead 23 pressed onto one end of the wire 2 and a loop fixing means 24 at the other end which is more completely described in FIG. 4E.

FIG. 4E shows a suspension wire 2 looped around on itself 25 and passed through a crimp 26 that has been pressed to hold it in place.

FIG. 4C shows an example of a continuous-wire suspension configuration 91. Continuous-wire suspension configurations are formed from one or many wires that do not usually terminate at the roller 3 or screen top rail 4 but will span connections between the top rail and the roller 3. Continuous-wire suspension configurations have from one to many continuous-wire suspension components 21. FIG. 4C shows a screen suspension formed from a single continuous-wire suspension component. An example of a continuous-wire suspension component is shown in FIG. 4F.

FIG. 4F show an example of continuous-wire suspension component, which is composed of a suspension wire 2 that has a terminating bulb or bead 23 pressed to both ends. It is known that a continuous-wire suspension component can also have a loop fixing means 24 if the continuous-wire suspension component terminates at the top rail 4.

FIG. 4L shows and close-up example of a continuous-wire suspension component passing through a roller pass through point 28. A roller 3 pass through point 28 allows the suspension wire 2 to be attached to the roller but to continue to pass through to other points. FIG. 4K shows a close-up example of top rail 4 pass through point 17. A top rail 4 pass through point 17 allows the suspension wire 2 to be attached to the top rail but to continue to pass through to other points. It is usual for stability of suspension that top rail pass through points 17 provide a tightening or locking mechanism so that once a suspension is defined the continuous-wire suspension wires 21 are fixed in position and no longer will permit a suspension wire 2 to pass through. Such a device is shown in FIG. 4K. No such device is required for roller 3 pass through points as one wind of the roller will effectively lock the suspension wire 2.

FIG. 4G shows an overview of a multi-wire suspension configuration. FIG. 4I shows a close up of the attachment of a multi-wire suspension component 20 to the top rail 4. In FIG. 4I the looped end 26 is passed through fixing aperture 27 the beaded end 23 is then passed through the loop 26 and up to the roller 3. FIG. 4H shows the beaded end or terminating bulb 23 and the slotted fixing aperture 19 that receives and locks in the terminating bulb.

FIG. 4J shows an overview of a continuous-wire suspension configuration with the roller pass through points 29 and roller 3 terminations 32 highlighted.

FIG. 4L shows a single continuous-wire suspension component 21 passing through a roller pass through point 28, which is attached to roller 3. FIG. 4K shows suspension wire 21 passing through apertures 17 and double looped to provide a lock to the continuous-wire 21 which tighten when screen top rail 4 is in the operating position.

It is known that alternative termination means can be utilised for suspension lines or wires within the parameters that alternative termination means should be precisely implemented on every suspension line or wire, should be strong enough to equal or exceed suspension wire strength and should not create anomalies to the screen texture or surface including bumps, lumps or other imperfections, or generally interfere with a natural smooth wind of the screen.

It is also understood that another example of attachment of the suspension lines or wires to the screen top rail is to take the terminating end for the screen top rail of the suspension lines or wire and permanently press it into the screen top rail. It is also understood that this form of wire attachment will provide a more permanent form of attachment but will remove the ability for individual wires or lines to be replaced at a later date should a suspension wire be damaged or faulty.

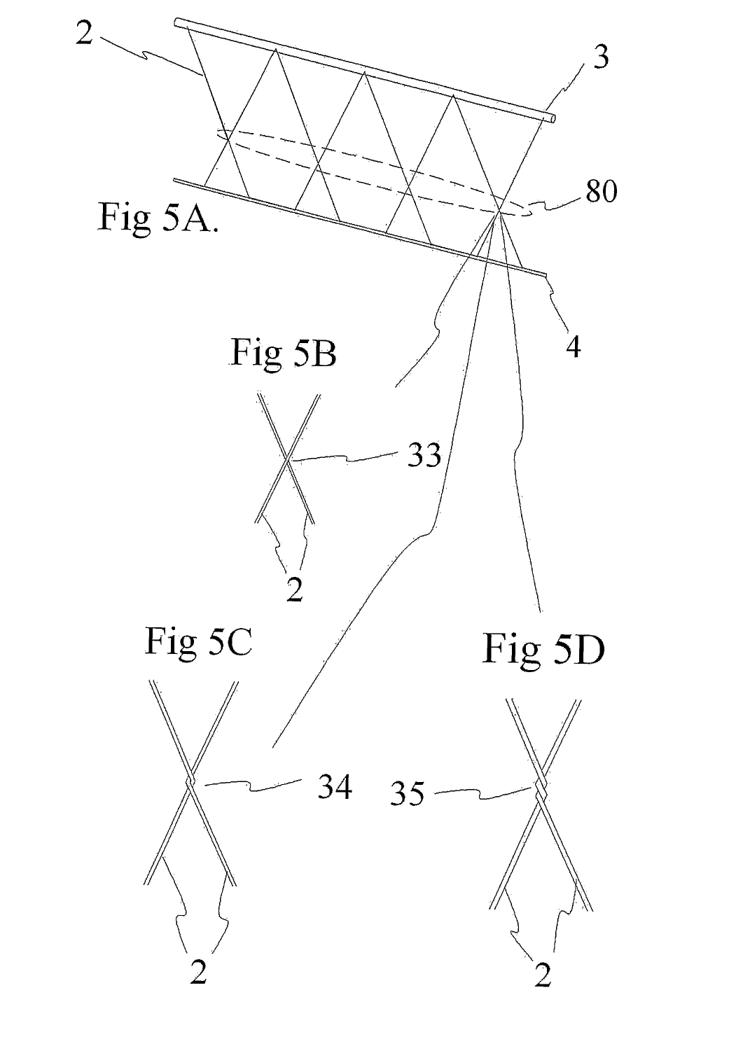

FIG. 5A shows a perspective overview of the screen suspension system basic components top roller 3, suspension wires 2 and screen top rail 4 with wire interaction points highlighted 80. FIGS. 5B 5C and 5D show different examples of suspension wire 2 interaction point 80 configurations. FIG. 5B shows an interaction point where both suspension wires 2 cross next to each other 33. FIG. 5C shows an interaction point where both suspension wires 2 wrap over each other 34 and perform a U-turn and pass down to the top rail 4 back in the same direction they originated from. FIG. 5D shows an interaction point where both suspension wires 2 wrap around each other 35 and continue on a diagonal path down to the top rail 4.

It is known that suspension interaction points 80 can incorporate two or many suspension wires 2. Suspension wires crossed next to each other 33 provides substantial lateral movement stability but are rigid and non self tensioning. Self-tensioning interaction points wrap over each other 34 and do not totally restrict lateral movement but are effective at absorbing any lateral movement energy and will return to natural inertia position easily. They also will adjust within the interaction point to provide more uniform tensioning within the interaction point and across the screen 1.

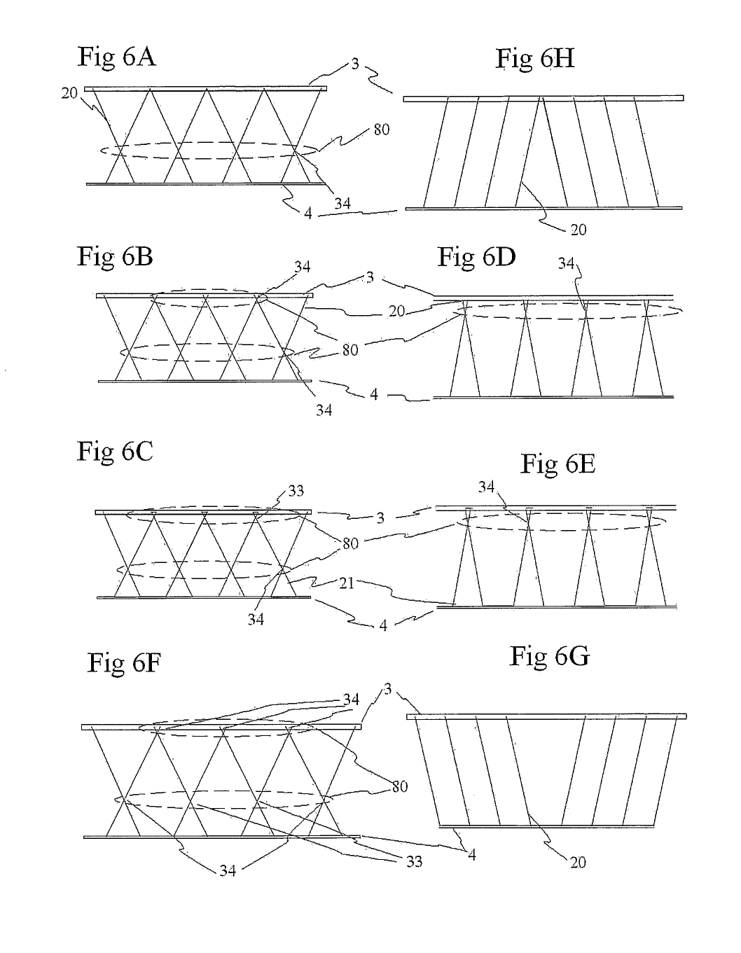

In FIGS. 6A through 6F it is shown that there can be multiple alternate example wire configurations composed of the components shown in FIGS. 4A though 4L and FIGS. 5A through 5D.

FIG. 6A shows an example suspension configuration composed of eight multi-wire suspension wires 20 and four interaction points 80. The interaction points for this example are of wrap over each other 34 interaction points. A wrap over each other 34 interaction point is shown in more detail in FIG. 5C.

FIG. 6B shows an example suspension configuration composed of eight multi-wire suspension wires 20 and seven interaction points 80. The interaction points for this example are of wrap over each other 34 interaction points. A wrap over each other 34 interaction point is shown in more detail in FIG. 5C.

FIG. 6C shows an example suspension configuration composed of one continuous-suspension wire 21 and seven interaction points 80. There are four wrap over each other 34 interaction points and three cross next to each other 33 interaction points. Interaction points are shown in more detail in FIGS. 5B, 5C and 5D.

FIG. 6D shows an example suspension configuration composed of eight multi-wire suspension wires 20 and four interaction points 80 arranged so as to position the interaction points higher in the suspension configuration. The interaction points for this example are of wrap over each other 34 interaction points shown in more detail in FIG. 5C.

FIG. 6E shows an example suspension configuration composed of one continuous-suspension wire 21 and four interaction points 80 arranged so as to position the interaction points higher in the suspension configuration. There are four wrap over each other 34 interaction points. Interaction points are shown in more detail in FIGS. 5B, 5C and 5D.

FIG. 6F shows an example suspension configuration composed of eight multi-wire suspension wires 20 and seven interaction points 80. There are five wrap over each other 34 interaction points and two cross next to each other 33 interaction points. Interaction points are shown in more detail in FIGS. 5B, 5C and 5D.

FIG. 6G shows an example suspension configuration composed of eight multi-wire suspension wires 20 arranged such that each wire is angled inwardly from the top of the suspension 3 to the centre of the bottom of the suspension 4 with no interaction points 80. The arrangement is such that the support wires are arranged in a balanced manner around the centre of the bottom of the suspension 4. The outer wires are fixed outside the line of the suspension 4.

FIG. 6H shows an example suspension configuration composed of eight multi-wire suspension wires 20 arranged such that each wire is angled outwardly from the top of the suspension 3 to the outer sides of the bottom of the suspension 4 with no interaction points 80. The arrangement is such that the support wires 20 are arranged in a balanced manner around the centre of the bottom of the suspension 4.

The screen system allows the screen to resist across the screen lateral deflection. The arrangement is such that the screen system will resist force or absorb motion artefacts such as pendulum motion. The arrangement is such that the screen is suspended in a stable manner to allow a quality image to be portrayed from the projector on the screen and the reliable return of the screen to the same position every time it is lowered.

Although the preferred embodiment described in FIGS. 1 to 7 for the screen system provides a system for raising, lowering and rolling up a projector screen it is understood that the screen system could be used to raise lower and roll up any screen or flexible flat surfaced article.

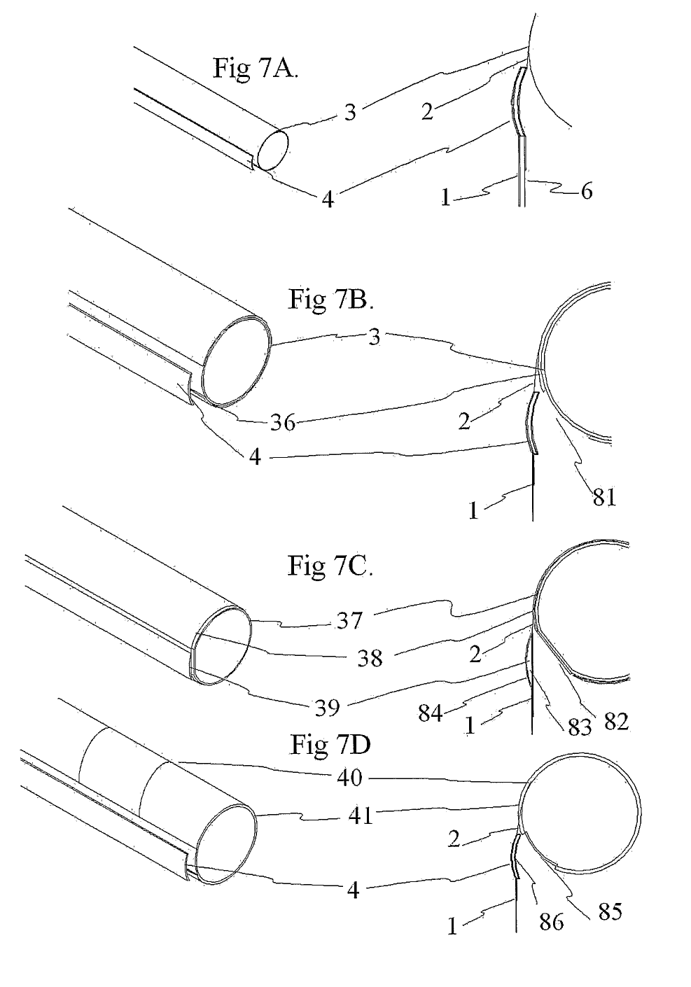

FIG. 7A shows the preferred embodiment of the roller 3, screen 1 top rail 4 and flexible anti-ridging material 6. This configuration of the winding management and anti-ridging component of the screen system is more completely described in FIGS. 2A, 2B, 2C and 2D.

FIG. 7B shows an alternate embodiment of the winding management and anti-ridging component of the screen system. The roller 3 has a covering 36 of sufficient thickness that wraps around the roller's 3 length excluding an area equivalent to the area of the top rail 4 creating a recess 81. The suspension wires 2 when screen 1 is wound up are absorbed in the covering 36. The top rail 4 is coordinated to arrive and be absorbed into recess 81. No anti-ridging material is required on the back of screen 1.

FIG. 7C shows an alternate embodiment of the winding management and anti-ridging component of the screen system. A flat sided roller 37 is cylindrical accept for a flat side 82 which has an area equal to the base 83 of the top rail 39. The top rail 39 has a front side curvature 84 equal to the curvature of the roller 37. The backside of the top rail 83 can be flat or concave. The roller 37 surface area accept for the flat side 82 has a soft covering 38 of sufficient thickness to absorb the wires 2. No anti-ridging material is required on the back of screen 1.

FIG. 7D shows an alternate embodiment of the winding management and anti-ridging component of the screen system. A roller 41 is cylindrical accept for a recess which has an area and depth equal to dimensions of top rail 4. The roller has cut into it predetermined V shaped channels 40 in which wires 2 are wound into. Usually no anti-ridging material is required on the back of screen 1.

It is known that the management and anti-ridging component of the screen systems absorbs the impact of wires 2 that precede the arrival of the screen 1 on the roller 3 and the top rail support 4. The utilisation of absorbing material 6, 36, 38 on the roller 3 or on the screen 1 provides insulation for the screen 1 from the presence of the wires 2 accepting where direct grooves or valleys are provided for wires 2 in roller 3. The absorbing material 6, 36, 38 also performs the function of absorbing the top rail 4 into an initial wind therefore removing the presence of the top rail accepting where a specific recess has been installed into the roller 3.

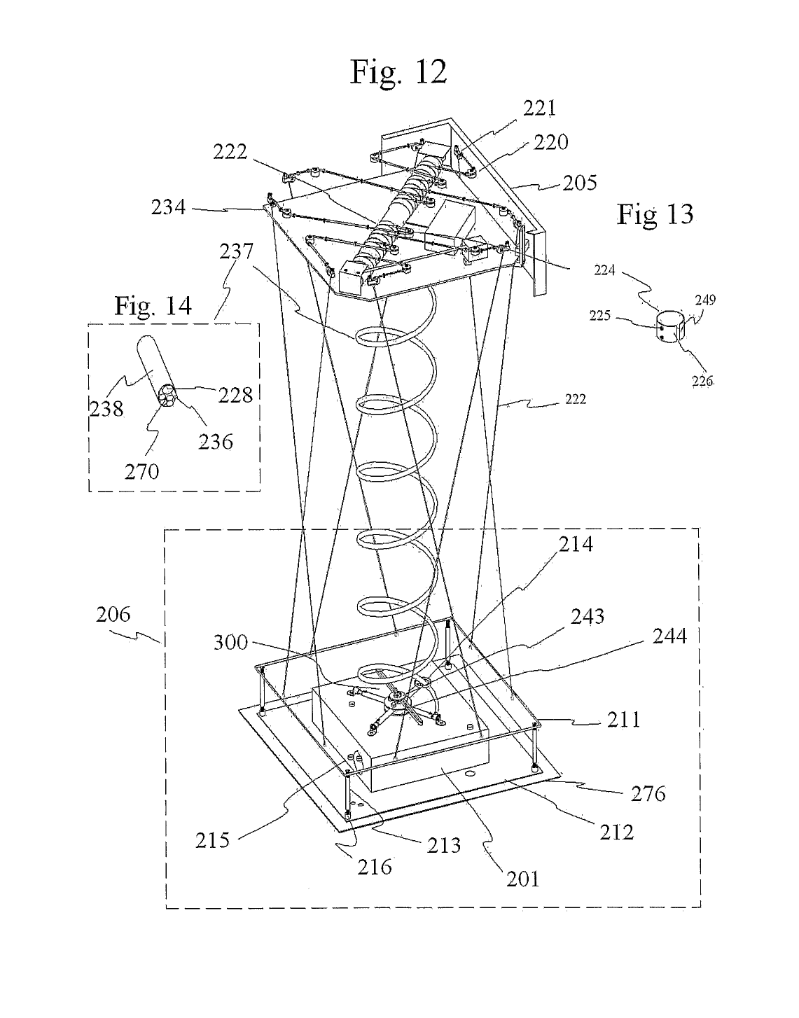

The projector system is shown with particular reference in FIGS. 8 to 27. FIG. 8 shows a projector carriage 206 in the elevated stored position whilst FIG. 12 shows the carriage 206 in the lowered or operating position. The projector 201 is supplied by others parties.

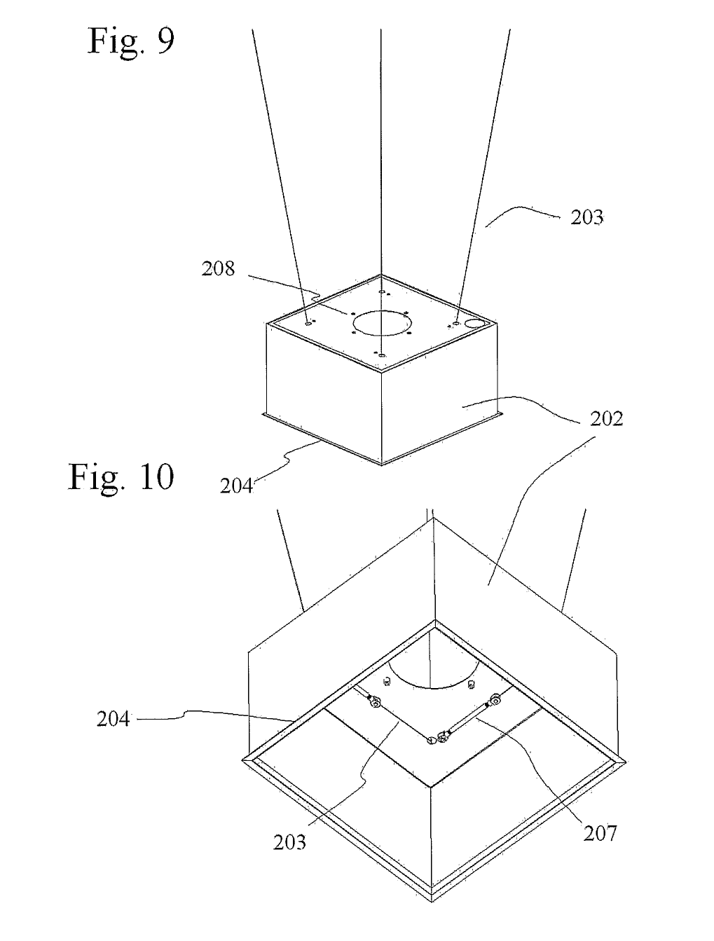

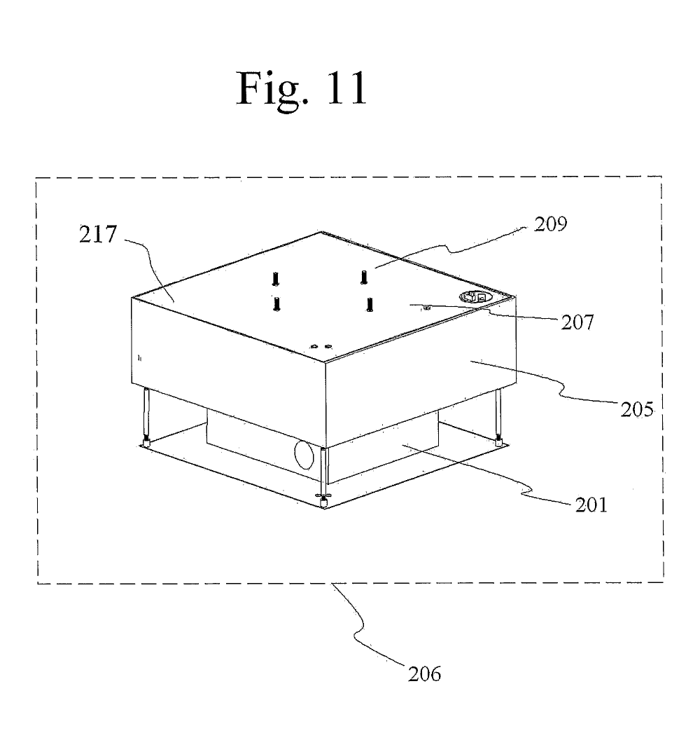

In FIGS. 9 and 10 a plenum housing of a metal box 202 of a square configuration has four sides, a top and an open base. The open base has a fixed return lip FIG. 11 204. The external box 202 can be mounted directly to a ceiling or could be housed within the ceiling.

In FIGS. 8, 10 and 11 the box 202 is mounted via wires to a roof or ceiling support structure via wires 203 which pass though an eyelet in the top of the box and are fastened to the top plate of the box via adjustable swages 207 which can be shortened or lengthened. An alternative means for suspending and adjustably mounting a projector is shown in FIGS. 29 to 35.

In FIG. 11, a second smaller metal box (cartridge box 205) of a square configuration has four sides, a top and an open base. In FIG. 11 the cartridge box 205 is mounted into the metal box 202 via fasteners 209.

The carriage 206 is described in FIGS. 11, 12 and 15. The projector 201 is centrally mounted in the projector carriage 206, which in turn is suspended below the cartridge box 205 via suspension wires 222 that are coupled to a roller 210 that is mounted in the cartridge box 205. Rotation of the roller 210 causes the suspension wires 222 to wind or unwind to cause the carriage 206 to move from the stored position in FIG. 8 to the in operational position in FIG. 12.

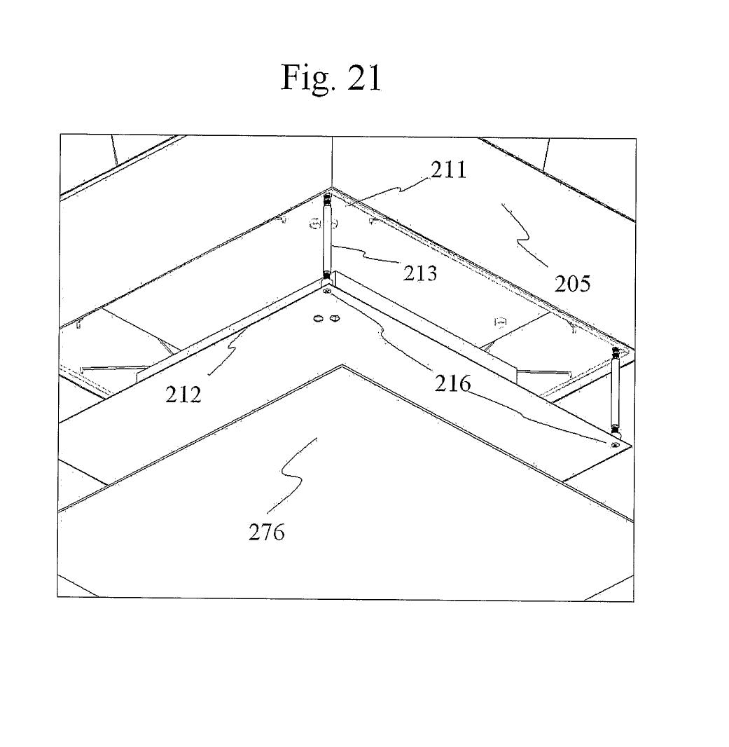

The carriage 206 is shown in more detail in FIG. 12 and FIG. 21. It comprises a top plate 211 in the preferred embodiment usually composed of a rigid polycarbonate or Perspex clear plastic and a bottom plate 212 composed of ferrous sheet metal. These are separated by four threaded telescopic columns 213 that are mounted in each corner and are adjustable through the turning of the column to consume more or less of the oppositely threaded screws at either end of the column. In this manner the spacing of the plates 211, 212 can be varied to accommodate projectors of differing dimensions. Nuts are provided on each of the threads of screws 216 to provide locking of position. Attached to the bottom plate 212 is a magnetic closure plate 276.

The bottom plate 212 can be removed by unscrewing the four screws 216. The top plate 211 includes an aperture 214 that allows the electrical and signal cables to be fed through to the projector 201.

Two tuning apertures 215 are on the bottom and top plates allowing access to set and fine tune the tubular motor 251 limit switches when the carriage is in the closed position.

The projector can be serviced and cartridge 205 can be removed or replaced from within the room it is installed without the removal of the plenum housing 202.

FIG. 12 shows the projector 201 secured to the top plate 211 via a universal mount turret 300. The universal mount turret 300 is shown in more detail in FIGS. 25 and 28. The universal mount turret 300 is fastened by a FIG. 12 wing-nut and washer 243 to the top plate 211 through the fastening aperture 244.

In the preferred embodiment the carriage 206 has eight wires 222 arranged in an octagonal pattern around the centre of the top plate 211.

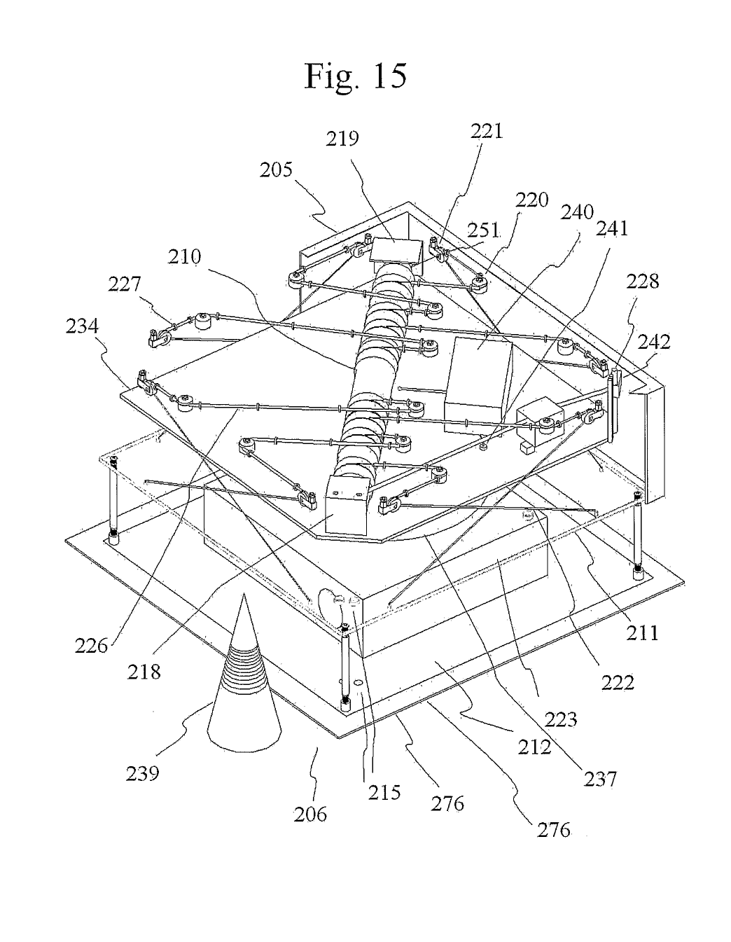

In FIG. 12 two of the sides and the top plate 217 FIG. 11 of the cartridge box 205 have been removed for clarity. In the preferred embodiment the cartridge box top plate 217 is arranged to support the roller 210 and tubular motor 251 through end brackets 218, 219 at each end of the motor 251 and also support an arrangement of horizontal and vertical pulleys 220 & 221 that are shown in FIG. 15. The tubular motor 251 and roller 210 can be mounted on the hypotenuse of the cartridge 205 so as to allow smaller motors to fit into the cartridge 205. As shown in FIG. 15 twelve pulleys 220 are horizontally mounted on their rotational axes and eight pulleys 221 are vertically mounted. The horizontally mounted pulleys 220 are arranged to provide the winding of the wires 222 at right angles to the axis of the roller 210 and also to provide the winding of wires at right angles to the vertical pullies 221.

The vertically mounted pulleys 221 direct the wires 222 from the roller 210 so that the horizontally mounted pulleys 220 have the effect of turning the wires 222 vertically downwards towards the carriage 206.

Four sets of two wires 222 extend down to each side of the top plate 211 of the carriage 206 in a criss-cross pattern for each side as displayed in FIG. 12.

The suspension wires 222 form a criss-cross pattern extending vertically upwards from each side to the vertically mounted pulleys 221 as shown in FIG. 12. The upper ends of each of the each suspension wires 222 pass through the pulleys 220 & 221 and are secured to adjustable collars 224 (FIG. 13) that are mounted coaxially with the roller 210 and held thereon by natural compression and further tightened with grub screws 225. Each collar 224 has a wire inlet aperture 226 through which the ends of the wire 222 are secured and knotted via knotting slot 249. Rotation of each collar 224 on the roller 210 enables fine adjustment of the wires 222. The adjustable collar 224 can have a magnetic covering to assist in the holding of wires 222.

As shown in FIG. 15 the suspension wires 222 are housed in plastic locators 226 that extend between the pulleys 220, 221 and act to ensure that the wires are at all times accurately aligned and positioned on the pulleys 220, 221. so that they do not become displaced from their positions. A plurality of circular cable ties 227 are used to hold the plastics tubes 226 on the top plate 217.

A preferred embodiment of the invention shows in FIGS. 14, 17 and 18, 19 a plurality of a video signal cables 270 and a single power cable 228 combined into an expandable braided sleeve 238 with a spiral memory wire 236. Other cable holding means to the braided sleeve may be used. The spiral memory wire has been precast to have and resist the lateral expansion of the spiral shape. This arrangement ensures that the power cable 228 and video signal cables 270 are reliably compressed into a compact spiral form when the carriage 206 is retracted as shown in FIG. 16. The cable manager 237, cables 270 and 228 are passed to the projector through a cable aperture 214 and up to the bottom plate of cartridge 234 and through the cartridge box 205

In FIG. 15 the base of the carriage 206 has a ferrous sheet metal base plate 212. The base plate has a magnetic cover plate 276 made from a magnetic sheet. The magnet attaches magnetically to the metal base plate 212. The magnetic cover plate 276 has the effect of closing off the bottom of the box 204 in the closed configuration thereby concealing the projector in the box without any fixing perforations. It also provides access to the projector 201 and cartridge when the carriage 206 is closed.

The top plate 211 has an aperture 244 to mount the projector centrally and to provide the ability to slide the projector 201 sideways within the carriage 206. This allows access to service the projectors air filter without the need to totally remove the projector from the carriage 206.

The projector system and arrangement of wires resist pendulum like swinging motions, either imparted to the articles through transferral of mechanical forces created in the lowering of the article or through interaction of articles with some external entity while suspended. The arrangement is such that the projector is suspended in a manner to allow a quality image to be portrayed from the projector on the screen and the reliable return of the article to the same position every time it is lowered or retracted. A wire tension sensor can be used to stop the roller winding when the wires are not tensioned.

The projector system approach is discrete and efficient and considerably less bulky compared with scissor linkages and other piston/cylinder actuating systems. The use of a suspension system means allows the driving means to be compressed into the smallest possible form.

The projector system invention shown in FIG. 15 utilises a control system which is composed of an external infrared receiver and wireless transmitter 239 and an in the box 205 wireless receiver and infrared transmitter 240 and 241. The receiver 239 receives the infrared signal command and translates it into a radio signal, which is transmitted to the receiver 240. The receiver 240 translates the radio signal back into an infrared signal and then transmits it into the projector box 202 via the infrared transmitter 240.

When the projector 201 receives a turn on signal from the infrared transmitter 240 the projector 201 starts to operate. A current sensor 242 senses a change in current and then switches a DPDT (Double Poll Double Throw) relay which switches the polarity of the power supply to the tubular motor 251 to unwind the wires on the roller 210 therefore lowering the projector 201. When the projector receives a signal to switch off and all projector-cooling fans have stopped the current sensor 242 detects a drop in current and switches the polarity via DPDT relay for the tubular motor which winds the wires on the roller 210 therefore moving the projector into the closed position. An override switch 280 is also provided for the relay to activate the tubular motor 251.

The current state of the art is that projector positioning and concealment devices and projector screens are triggered via a separate switch or remote control either infrared or wireless. The invention removes the need for any dedicated physical switch or a dedicated remote for the projector positioning and concealment device or any projector screen. The remote supplied as standard for projectors 201 is only required.

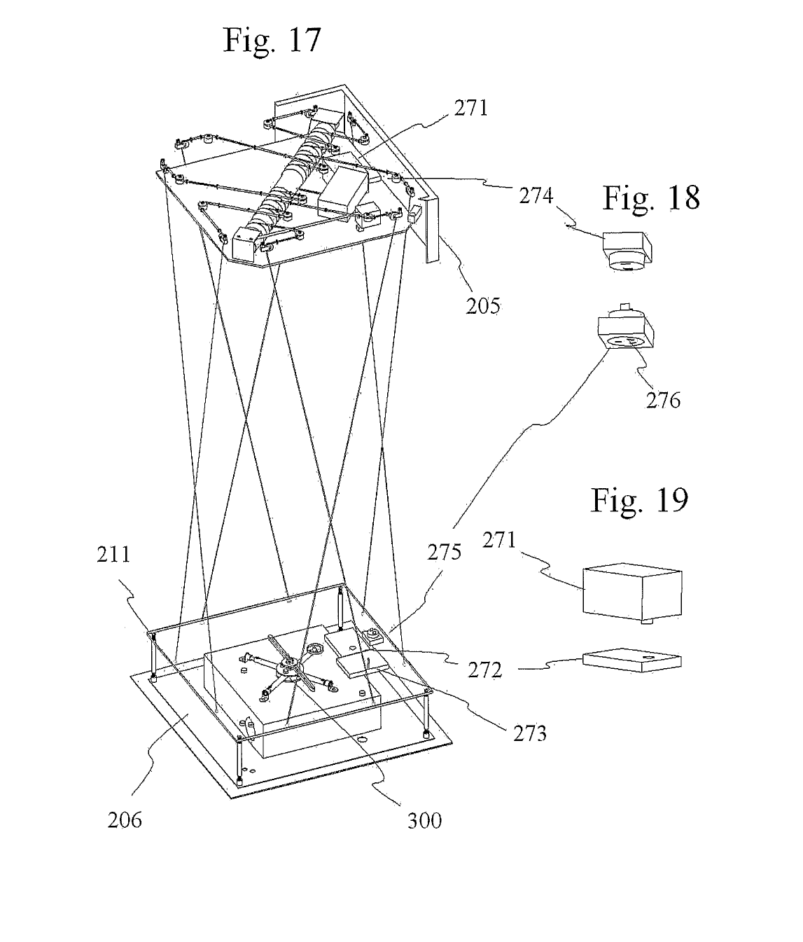

In FIG. 17 the carriage 206 is shown in a totally wireless embodiment. A laser transmitter 271 is included in the cartridge 205 that transmits video signals to the laser receiver 272 positioned on the carriage top plate 211. All video signals can be transmitted without wires.

Also FIG. 17 shows a wireless receiver or transceiver, which receives video signals by way of a radio frequency signal coming from wireless content providing devices such as local area networks, DVD players and HDTV set top boxes.

FIGS. 17 and 18 show a wireless power docking station. The cartridge 205 has a female receiver with positive and negative spring loaded internal contacts 274. The carriage top plate 211 has male positive and negative contacts that on contraction of the carriage 206 achieve contact with the female receiver 274 to create an electrical circuit to supply power to a device that is plugged into the female power point 276. The plugged in device would usually be a projector that has a battery powered power pack or a charger to a battery power pack.

As in the embodiment concerning the screen system control of the tubular motor 251 allows the units to be lowered to the operative position. It is understood that a variety of mechanisms can be used to control rotation of the tubular motor 251, most usually a rotational limit switch.

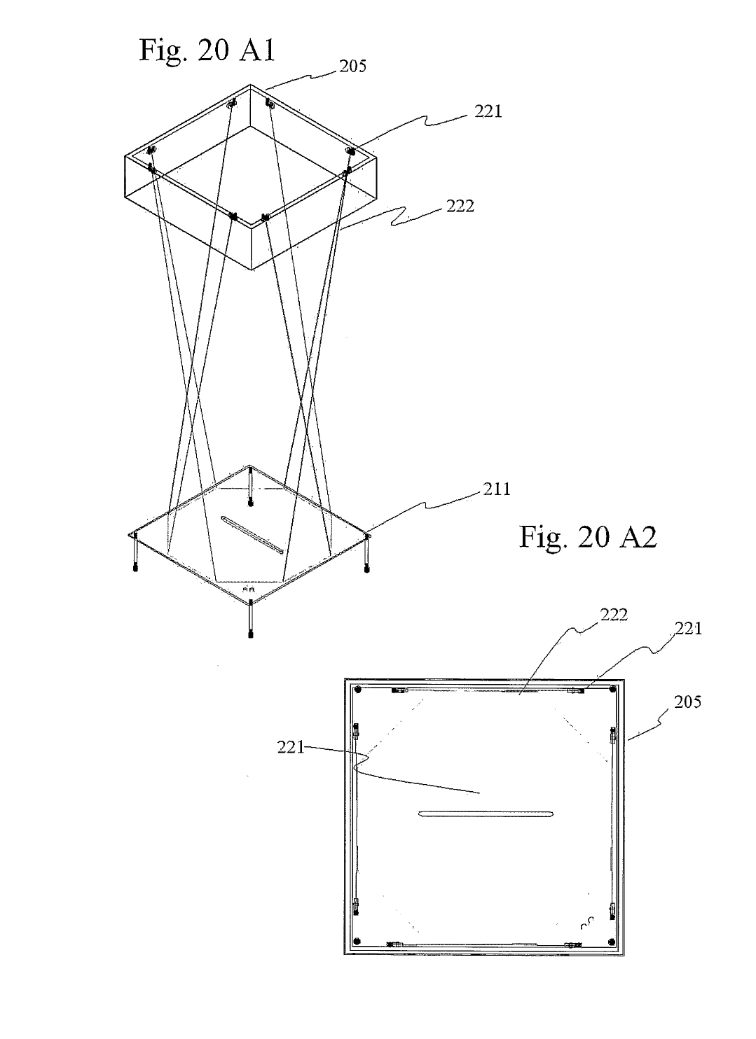

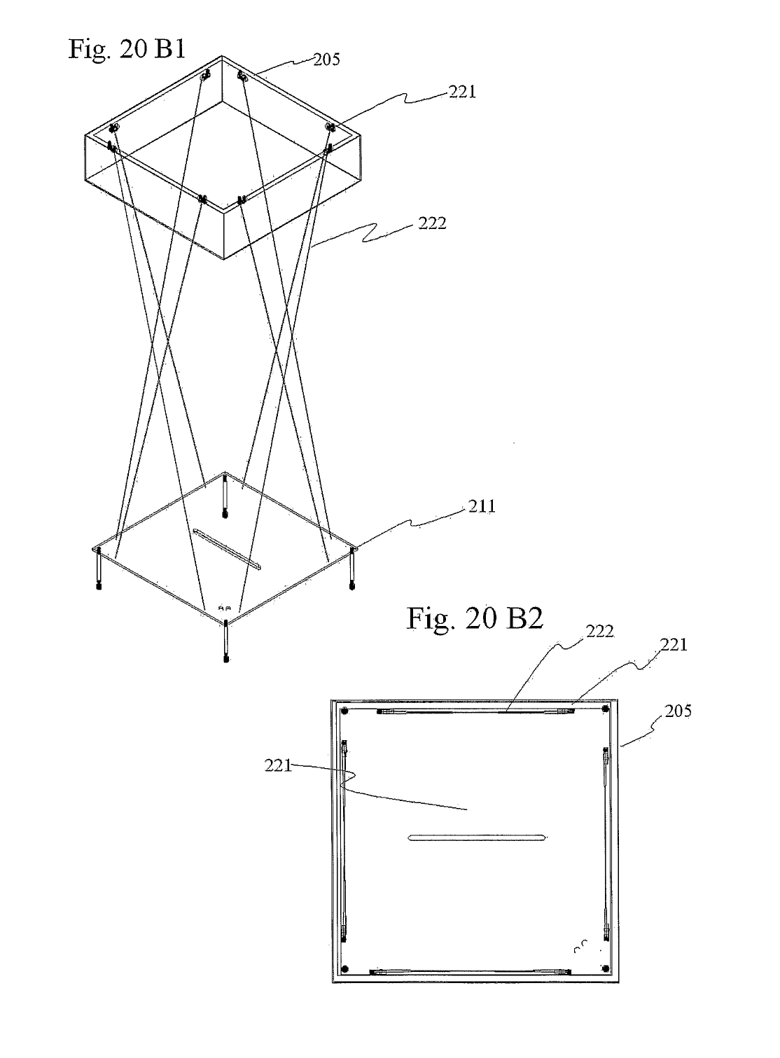

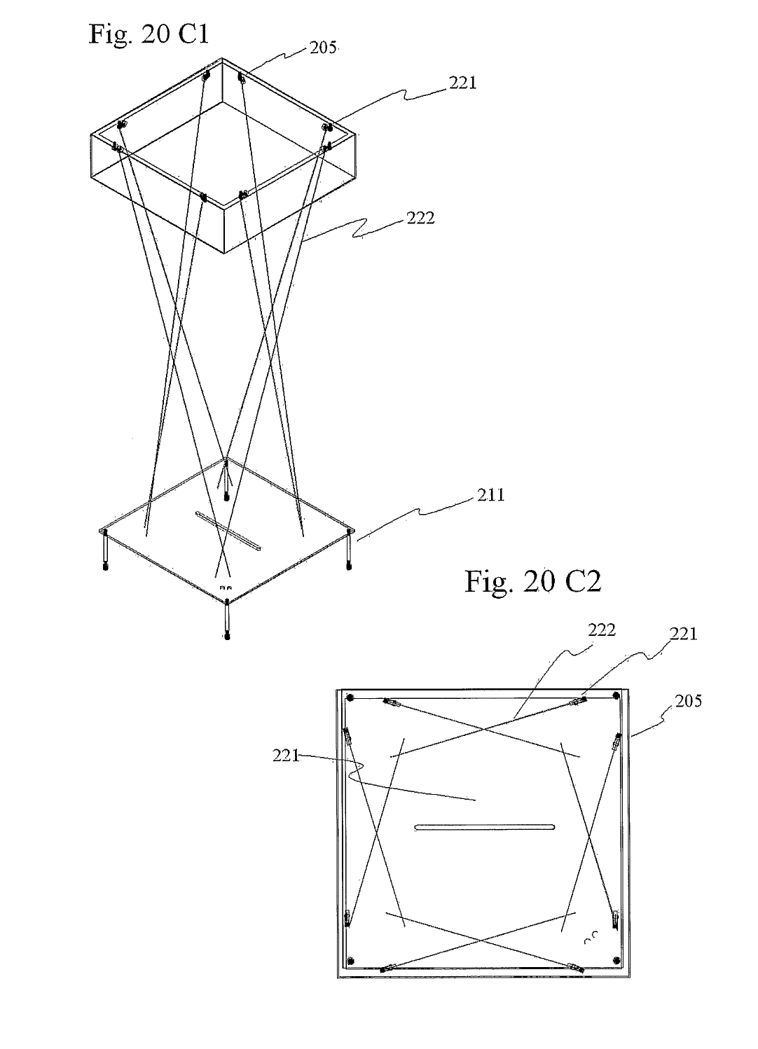

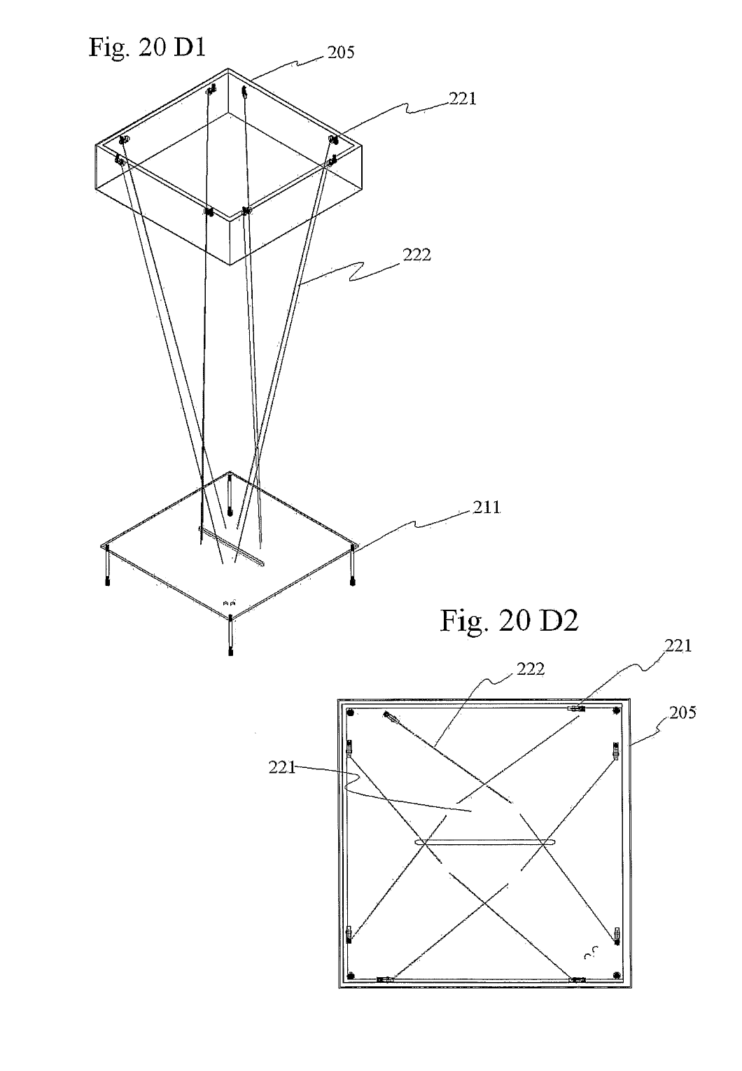

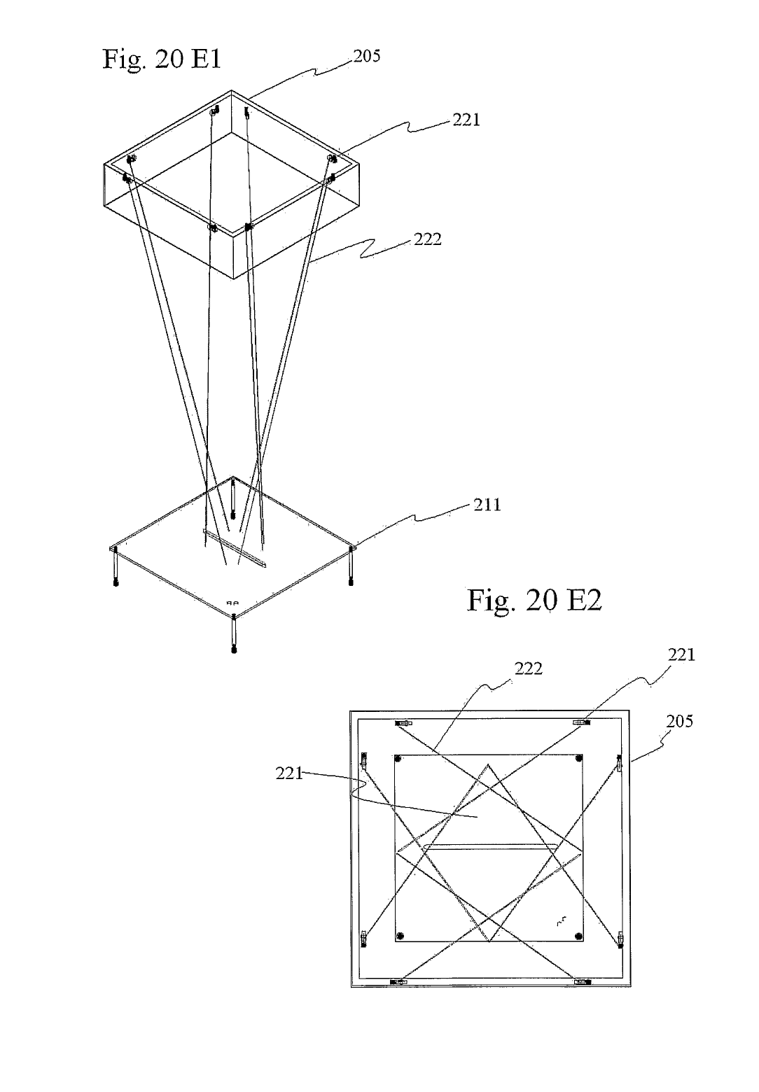

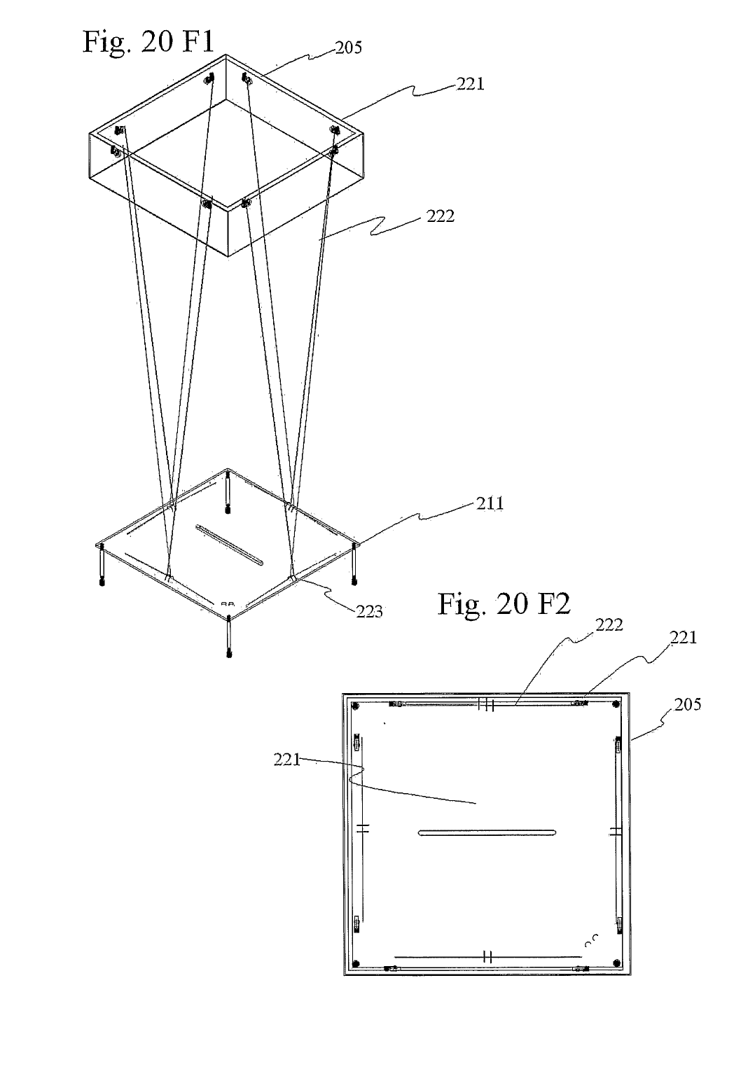

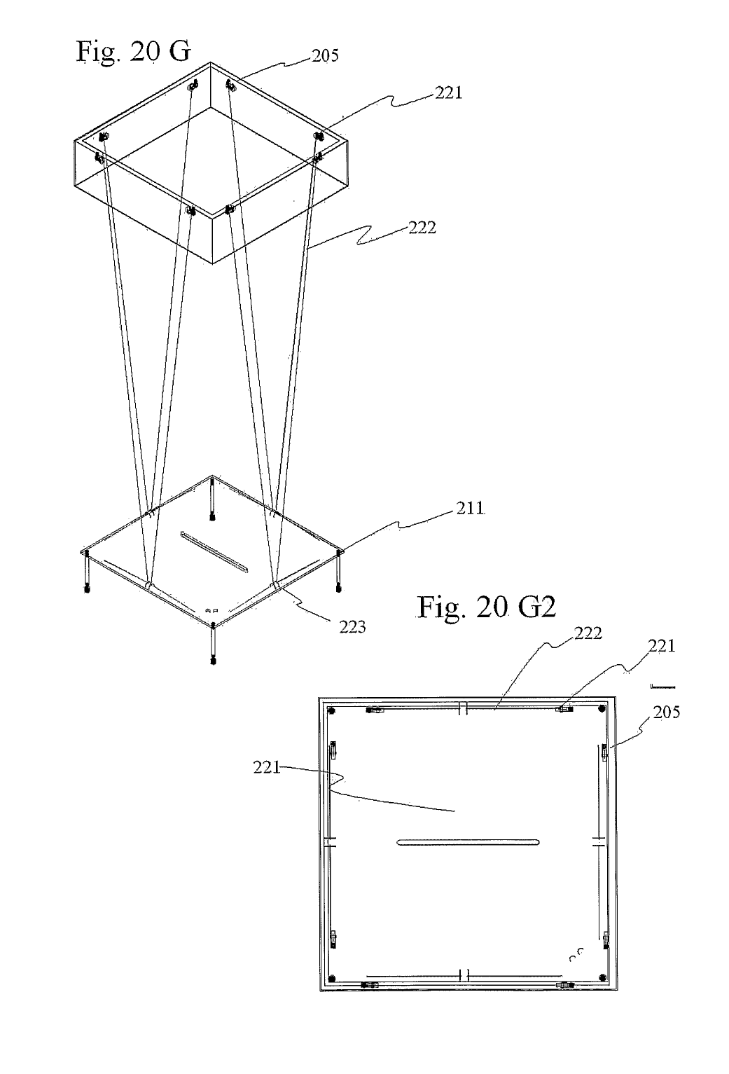

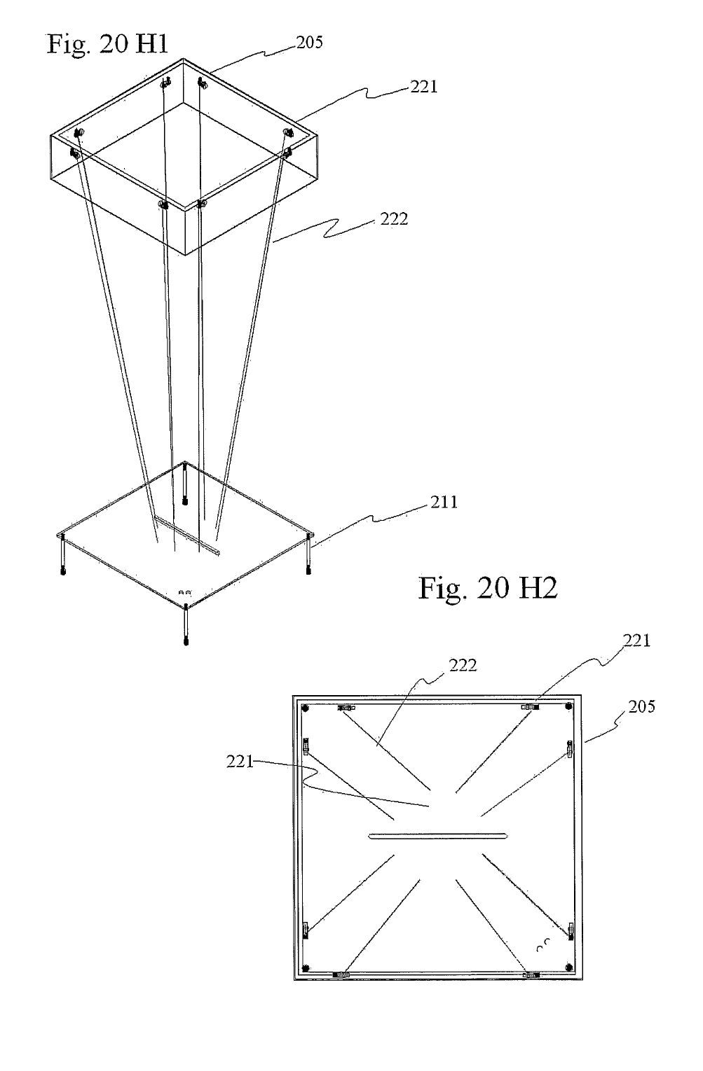

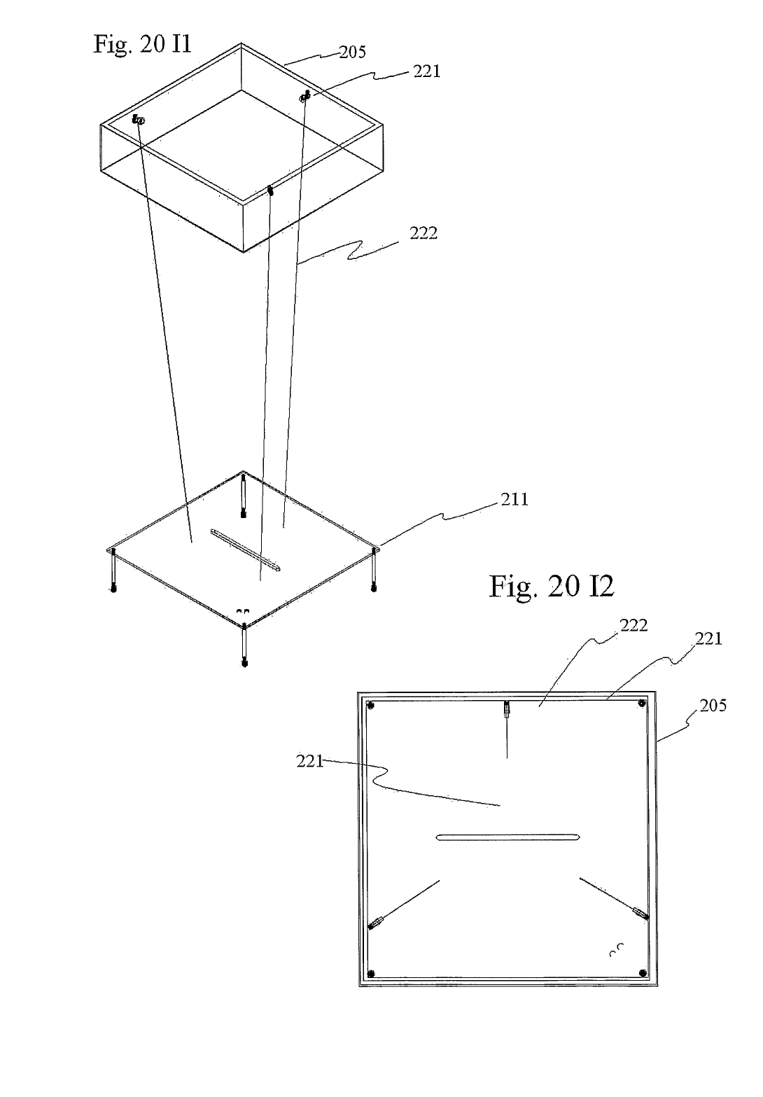

FIGS. 20A1 and 20A2 show a perspective view and top view of the preferred embodiment of the flexible suspension lines for the projector system invention. The cartridge 205 is shown as a see through entity. The cartridge 205 is shown with the required position of the vertical pullies 221 to support the suspension lines configuration. The suspension lines 222 are shown as extending from the vertical pullies 221 down to their attachment to the top plate of the projector carriage 221.

FIGS. 20B1 through 20B2 illustrate alternative example configurations for the flexible suspension lines of the projector system invention.

FIGS. 20B1 and 20B2 through 20E1 and 20E2 show perspective views and top views of alternative examples of the arrangement of flexible suspension lines. The cartridge 205 is shown as a see through entity. The cartridge 205 is shown with the required position of the vertical pullies 221 to support the suspension lines configuration. The suspension lines 222 are shown as extending from the vertical pullies 221 down to their attachment to the top plate of the projector carriage 221. Alternative wire 222 configurations impact the angular alignment of pullies FIG. 18 221 and 220.

FIGS. 20F1 and 20F2 through 20G1 and 20G2 show perspective views and top views of alternative examples of the arrangement of flexible suspension lines. The cartridge 205 is shown as a see through entity. The cartridge 205 is shown with the required position of the vertical pullies 221 to support the suspension lines configuration. The suspension lines 222 are shown as extending from the vertical pullies 221 down to and passing through ring stabilisers 223 and then attaching to the top plate 221 forming a triangular pattern.

FIGS. 20H1 and 20H2 through 20I1 and 20I2 show perspective views and top views of alternative examples of the arrangement of flexible suspension lines. The cartridge 205 is shown as a see through entity. The cartridge 205 is shown with the required position of the vertical pullies 221 to support the suspension lines configuration. The suspension lines 222 are shown as extending from the vertical pullies 221 down to a central deployment on the top plate.

It is known that example configurations in FIGS. 20A1 through 20I2 and variations thereof, all resist lateral deflection to varying degrees depending on angular deployment of flexible suspension lines. All suspension line configurations must be deployed in a centrally balanced angular fashion around or across the article. Suspension lines can be equally crossed and weight distribution of an article should be to the centre of the suspension line points.

Although the preferred embodiment described in FIGS. 8 to 21 for the projector system describes a system for positioning a projector it is understood that the system could be used to position any article.

In FIG. 25 a preferred embodiment of an universal projector mount assembly 300 deployed in a ceiling is shown. A right angle bracket 302 is secured to a ceiling joist 324 or other ceiling infrastructure. A threaded suspension rod 303 is fastened onto the right angle bracket 302 by a nut above and below the horizontal arm of the bracket. A plaster collar 314 surrounds and finishes the aperture in the ceiling 312.

A cable management tube 301 extends from below the ceiling into the roof cavity over the threaded rod. Power and signal cables 310 pass through the tube between the threaded rod 303 and the inner side of the tube.

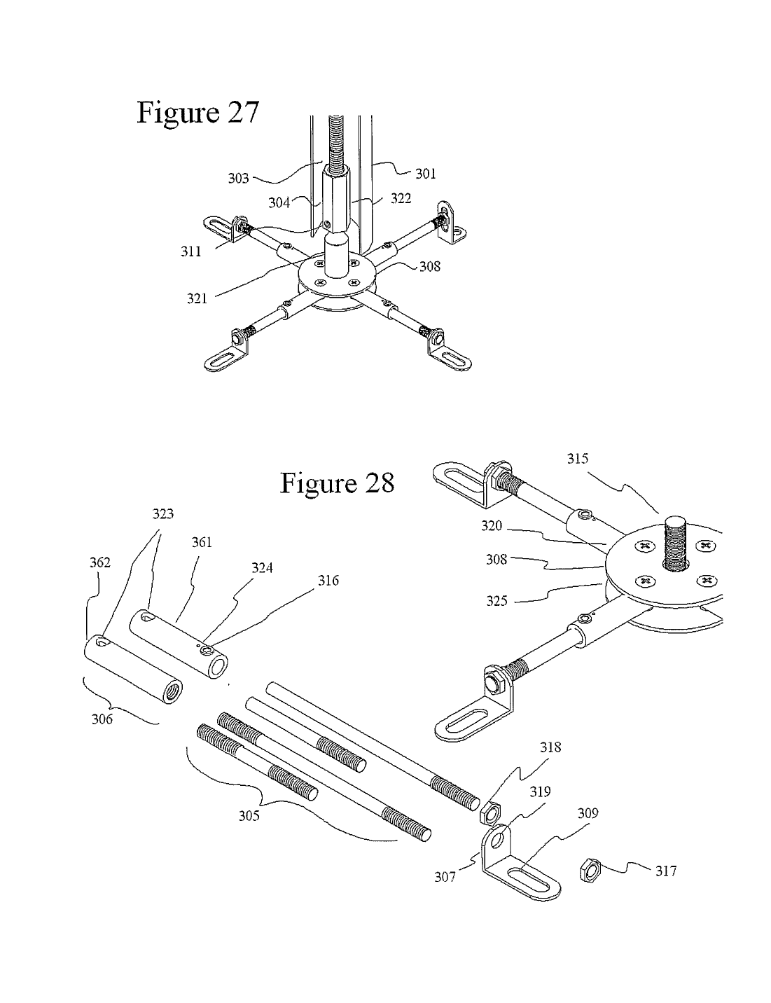

As shown in FIG. 27 at the bottom of the suspension rod 303 a universal mount 300 is screwed onto the threaded rod via the connecting sleeve 322 which is the top part of ball joint 304. The universal mount 300 is designed to be fastened to a range of projectors 313.

The universal mount assembly 300 is illustrated in FIGS. 27, 28 and essentially comprises a central hub having radially extending tubular arms of adjustable length. The small ball joint 304 is composed of a freely moving ball and socket with threaded connector sleeves at both ends 321 and 322. The end of each arm is adapted to be secured to the upper surface of most projectors. The top part 322 of the ball joint 304 has a small grub screw 311 to lock the movement of the sleeve and therefore to position the projector

The lower part 321 of the ball joint 304 is fastened onto a central turret or hub 308 via a spigot 315 that passes through a top plate 320 of the central hub. The top of the sleeve 304 with the universal mount 300 is screwed into the bottom end of the suspension rod 303.

The universal mount arm assemblies are described in FIG. 28. There are at least 2 interchangeable arms. Each arm is composed of one of many interchangeable sockets 306 varying in length with a grub screw 316 and mounting holes 323. The sockets 306 are secured between parallel circular plates 320 and 325 that make up the hub 308 to extend radially from the hub. Each arm radiates horizontally from the centre and is arranged on a single horizontal plane. Each interchangeable socket 306 can receive one of the interchangeable threaded rod arms 305 and is locked into place by the tightening of the grub screw 316. A small aperture 324 is provided behind the grub screw 316 so the installer can gauge a safe insertion of an interchangeable arm 305.

Different interchangeable arms 305 when used with interchangeable sockets 306 results in a continuous analogue array of mounting points to reach the a projector's mounting points. Each interchangeable threaded rod arm 305 has a thread on the outer end that can receive the projector connector bracket 307. Connector bracket 307 is a universal connector that can be selected for mounting to flat surfaced projectors or for mounting to projectors with irregular mounting surfaces.

The vertically adjustable connector side of the bracket 307 has two nuts 318 and 317 to lock the bracket at the desired height. The regular hole of the bracket 319 provides adjustment horizontally and is locked by nuts 318 and 317.

FIG. 22A shows a perspective illustration of the screen 19 with four removable rectangular masks 11 applied to it. FIG. 22B shows in more detail a cross section of a removable mask 11. Each mask 11 is composed of light absorbing material 12 on the projector facing side of the mask 11 and a magnetic material 13 is bonded to the back of the light absorbing material 12. The magnetic material 13 is usually a flexible magnetic rubber sheet. The light absorbing material is preferably a black absorbing fabric such as a felt, velvet, paper, paint or other similar material. FIG. 22B describes four different treatments 19 to the screen 1 to prepare it for accepting the removable mask 11. The arrow 16 shows the direction that the mask is applied to the screen treatment examples 19. Screen treatment example shown in FIG. 22B1 shows the screen 1 with the ferrous material 14 bonded to the back of the screen 1. The screen treatment example shown in FIG. 22B2 shows the screen 1 with the ferrous material 14 bonded to the front with a separate screen coating 18 applied to the ferrous material.

The screen treatment example shown in FIG. 22B3 shows the screen 1 with the magnetic material 13 bonded to the back of the screen 1. The screen treatment example shown in FIG. 22B4 shows the screen 1 with the magnetic material 13 bonded to the front with a separate screen coating 18 applied to the front of the ferrous material.

It is understood that when the screen coating 18 and ferrous material 14 or the screen coating 18 and the magnetic material 13 are adjacent to each other that they could be formulated into a single component.

FIG. 23A shows a perspective illustration of the screen 17 with four removable rectangular masks 15 applied to it. FIG. 23B shows in more detail a cross section of a removable mask 15. Each mask 15 is composed of light absorbing material 12 on the projector facing side of the mask 11 and a ferrous material 14 is bonded to the back of the light absorbing material 12. The ferrous material 14 is usually a coating of an iron-based material. The light absorbing material is preferably a black absorbing fabric such as a felt, velvet, paper, paint or other suitable material. FIG. 23B describes two different treatments 17 to the screen 1 to prepare it for accepting the removable masks 11. The arrow 16 shows the direction that the mask is applied to the screen treatment examples 17. The screen treatment example shown in FIG. 23B1 shows the screen 1 with the magnetic material 13 bonded to the back of the screen 1. The screen treatment example shown in FIG. 23B2 shows the screen 1 with the magnetic material 13 bonded to the front of the screen 1 with a separate screen coating 18 applied to the front of the magnetic material.

FIG. 23C shows a perspective illustration of the screen 61 with four removable rectangular masks 60 applied to it. FIG. 23D shows in more detail a cross section of a removable mask 60 which is comprised of light weight plastic sheet 60 preferably polyethylene plastic or foam that is attached to the screen in the direction of arrow 16 by static electricity to a non-conductive surface 18 coated on the front surface of the screen 1. It is recognised that this mask can be used in any situation where a non-conductive surface is present and a charge can be maintained to the mask.

The use of masks 11, 15, 60 for screen 1 allows the correct framing of visual content that is projected in different aspect ratios from the physical screen. For example Cinemascope 2.35:1 on a standard HDTV aspect ratio screen 16:9. Proper framing produces an improvement in the perceived contrast of an image.

In FIGS. 22B, 23B, 24B, 24D and 24F the direction of the magnetic attraction is identified by the arrow 70.

FIG. 24A shows a perspective illustration of the wall 50 with four removable rectangular masks 51 applied to it. The masks 51 are arranged to dynamically boarder a rectangular projected image. Therefore facilitating an improvement in perceptible contrast and therefore image quality. The invention provides the dynamic creation of one or many bordered virtual projector screens. Each virtual projector screen is composed of one or many screen masks 51 and are generally arrange to closely boarder the aspect ratio of the image being displayed. FIG. 24B shows in more detail a cross section of a removable mask 51. Each mask 51 is composed of light absorbing material 12 on the projector facing side of the mask 51 and a magnetic material 13 is bonded to the back of the light absorbing material 12. The magnetic material 13 is usually a flexible magnetic rubber sheet. The light absorbing material is preferably a black in colour light absorbing fabric such as a felt, velvet, paper, paint or other similar material. FIG. 24B describes two different treatments 52 to the wall or suitable flat surface 50 to prepare it for accepting the removable masks 51. The arrow 16 shows the direction that the mask is applied to the screen treatment examples 52. The screen treatment example shown in FIG. 24B1 shows the wall 50 with the ferrous material 14 usually an iron-based material bonded to the front of the wall 50 that is then coated with a separate protective and aesthetic screen layer 18. The screen treatment example shown in FIG. 24B2 shows the screen 1 with the magnetic material 13 bonded to the wall 50 that is coated with a separate protective and aesthetic screen layer 18. It is also known that any ferrous material to magnetic material can be alternatively be provided by a magnet to magnet option.

The embodiment shown in FIG. 24A shows the masks 51A and 51B which are mathematically proportioned and arranged to form a border to an internal area which has generally an aspect ratio of 16 units wide on the horizontal plane by 9 units high. The border when arranged for this aspect ratio will form a completely squared border frame without any overhang outside the formed rectangle. The height of top and bottom masks 51B are such that when moved toward the centre and aligned with the top and bottom respectively of the side masks 51A the internal bordered area will have generally an aspect ratio of 2.35 units wide to 1 units high and a completely squared boarder frame without overhang outside the formed rectangle. This effectively provides masking borders for two different screen aspect ratios in common use. This facilitates the removal of the non black borders that are created when content is displayed on a HDTV 16 by 9 projector that has a natural aspect ratio of cinemascope or 2.35 to 1.

The side masks 51A have embedded in them two reverse magnets 51B1 the magnetic side facing the light absorbing side of the mask so as to provide a holding force when top and bottom masks 51B are placed over them when deploying the masks to provide an internal screen area of 2.35:1 aspect ratio. The reverse magnets 51B1 can be at the ends of the mask or can run through the mask as one continuous piece.

In another embodiment the top and bottom masks 51B can be divided into two separate pieces for ease of handling. This provides a masking system with 6 pieces. The side masks 51A can also be divided into two separate pieces. These masks can then be arranged into an alternative smaller configuration.

FIG. 24A also shows an optional one or two insertion horizontal mask 51E which generally has the vertical height equivalent to the difference between a 2.35 to 1 screen and a 16 to 9 aspect ratio screen with the same width. The insertion masks 51E can be inserted below the top mask and above the bottom mask 51B, alternatively to the movement of the bottom and top masks 51B. The insertion horizontal masks 51B1 can be of the same width but will generally be shortened by the width of the vertical masks 51A.

FIG. 24A2 shows an alternative embodiment of the invention described in FIG. 24A. In FIG. 24A2 the perspective illustration of the wall 50 with four removable rectangular masks 51 applied to it. The top and bottom rectangular masks 51D and the side masks 51C are arranged to form an internal screen area of 16 units high by 9 units wide with no border overhang. Or alternatively are arranged to form an internal screen area of 4 by 3 units or 2.35 units to 1. In this configuration the borders or masks are generally arranged into a fixed aspect ratio and the horizontal masks 51D are butted into the side masks 51C instead of overhanging like the horizontal masks 51B as shown in FIG. 24A. Aspect ratio modification is provided by two insertion horizontal masks 51E as shown in FIG. 24A.

In another embodiment the masks 51A and 51B are mathematically proportioned for and arranged to form a boarder of an internal area which has generally an aspect ratio of 4 units wide on the horizontal plane by 3 units high on the vertical plane. The border when arranged for this aspect ratio will form a completely squared border frame without any overhang. The height of top and bottom masks 51B are such that when moved toward the centre and aligned with the top and bottom respectively of the side masks 51A the internal bordered area will have generally an aspect ratio of 16 units wide to 9 units high and a completely squared border frame without overhang.

In the preferred embodiment one or many sets of masks that provide many virtual projector screens as described above can be provided. The preferred embodiment provides the ability to completely remove the border masks and therefore the screen when not in use. The masking borders can be constructed to be flexible or stiff.

FIG. 24C shows a perspective illustration of the wall 50 with four removable rectangular masks 53 applied to it. FIG. 24D shows in more detail a cross section of a removable mask 53. Each mask 53 is composed of light absorbing material 12 on the projector facing side of the mask 53 and a ferrous material 14 is bonded to the back of the light absorbing material 12. The ferrous material 14 is usually a coating of an iron-based material. The light absorbing material is preferably a black absorbing fabric such as a felt, velvet, paper, paint or similar material. FIG. 24D describes a treatment 54 to the wall 50 to prepare it for accepting the removable masks 53. The arrow 16 shows the direction that the mask is applied to the wall treatment example 54. The screen treatment example shown in FIG. 24D shows the wall 50 with the magnetic material 13 bonded to the wall 50 that is coated with a separate protective and aesthetic layer 18.

FIG. 24E is a perspective illustration of a fixed screen broken down into components positioned in order of assembly a short distance from a wall. FIG. 24E shows a perspective illustration of the wall 50 with two sheets of a magnetic and wall texture absorbent material 58 and a screen 57 with four removable rectangular masks 59. FIG. 24F shows in more detail a cross section of a removable mask 59 and screen 57 and wall texture absorbent material 58. Each mask 59 is composed of light absorbing material 12 on the projector facing side of the mask 59 and a ferrous material 14 or a magnetic material 13 is bonded to the back of the light absorbing material 12. The ferrous material 14 is usually a coating of an iron-based material. The light absorbing material is preferably a black absorbing fabric such as a felt, velvet, paper, paint or similar material. The magnetic material is usually flexible magnetic sheet. The arrow 16 shows the direction that the mask is applied. FIG. 24F shows the magnetic and wall texture absorbent material 58 which is composed of magnetic material 13 with absorbent material 55 and a bonding agent which is used to bond 58 to the wall 50. FIG. 10F shows the screen 57 that is composed of a material suitable for making a screen 18 bonded with a ferrous material 14. The wall texture absorbent material can be soft closed cell foam.

It is understood that when the magnetic material and absorbent layer are adjacent to each other that these components could be formulated into a single component. For example the magnetic material can be cast into rubber, which can serve the dual purpose of texture absorbent layer and magnetic material.

In FIG. 38 a preferred embodiment of the adjustable suspension mount 400 is shown with a universal projector mount 414. The adjustable suspension mount provides a means to adjustably mount a projector or other article. The device provides secure and flexible fastening as well as dynamic movement of the article with three degrees of freedom, pitch, yaw and roll.

The adjustable suspension mount is composed of a top support means or top plate which is attached to a ceiling or other structure and a bottom support means usually a bottom plate interconnected via a plurality of flexible suspension lines that are formed from a continues flexible wire or other suitable material and arranged between the top and bottom support means. The flexible suspension lines being spaced apart to provide hanging support with resistance to lateral movement for the projector or article when the mass of the article is being supported.

The adjustable suspension mount is composed of an arrangement of top and bottom support means so as to allow movement of a continuos wire through the top and bottom support means interface eyelet points. Variable degrees of adjustability is provided by use of gravity and the tightening of the continuous wire on the eyelets.

The arrangement is set so that the continuous flexible wire resists movement through the interface eyelet points when the mass of the article is fully suspended via the mount, therefore locking the article into position. Adjustability of the article is available when some of the articles mass is removed by external support of the article, therefore allowing dynamic adjustment of the article.

When the article is fully suspended the continuous wire is arranged to create a web pattern usually in a criss-cross form which limits the movement of the article in one or many directional planes.

The arrangement provides movement of the supported article with three degrees of freedom, pitch, yaw and roll. The mass of the article or projector being mounted should be centrally balanced to provide the greatest degree of movement for each plane. The mass of the projector or article should be transferred to the suspension mounting assembly via a central fixing point.

In FIG. 29 a projector mount assembly is shown composed of a top fixing plate 401 and a bottom mounting plate 404. Interconnecting the top fixing plate 401 and the bottom mounting plate 404 is a continuous wire 403 threaded through the plates 401 and 404.

In the preferred embodiment the fixing top plate 401 generally has 4 pairs of eyelet holes 420 arranged to the outer extremities of the plate 401. The mounting bottom plate 404 generally has 4 sets of eyelets 411 arranged to the outer extremities of the plate 404. The eyelet holes 411 in FIG. 30 and 420 in FIG. 31 have a diameter generally twice the thickness of the continues wire 403. All eyelets should be formed with rounded edges on entry and exit as shown in FIGS. 31 and 30.

The continuous 403 wire is threaded through top fixing plate 401 via the eyelet 422 and around once and out through eyelet 421 in the manner shown in FIG. 31. The continuous wire 403 is then passed to the bottom plate 404 diagonally in the fashion shown in FIG. 29 and through the eyelet 413 as shown in FIG. 30 under the plate 404 and back through the eyelet 402 in the horizontal direction of the incoming continuous wire 403 as shown in FIG. 30. This is repeated to functionally form multiple suspension lines.

It is understood that there can be many configurations of eyelets and suspension lines with similar functionality. For example eyelets 410,412,413 could be threaded in the opposite way with the continuous wire 403 from the top plate 401 being inserted into 410 or 412 and then into and exiting from eyelet 413 to be passed to the next set of bottom plate 404 eyelets 411. It is also understood that eyelet 413 could be eliminated by utilising eyelets 410 and 412 to carry both intersecting wires overlayed. Entry at 412 and exit at 410 and vice versa. This will provide some conflict between intersecting wires. It is understood if thin continuous wire 403 is used then extra winds can be executed for any eyelet group 420 and 411.

When the continuous wire has been threaded through all eyelet sets 420 and 411 the continuous wire ends 434 and 435 will meet on one side of the bottom plate 404 as shown in FIG. 29 and in more detail in FIG. 32. These continuous wire ends must be joined to form a continuous wire web or loop.

A continuous wire loop is formed by the application of a wire crimp 433 or a wire clasping type device 435 shown in FIG. 32. The wire clasping device as shown in FIG. 32 is composed of a small usually metal tube 431 with an inside diameter proportional to the size of the wires to be clasp. Two small threads are inserted into the side of the tube 431 and two small screws 432 are inserted that when fully screwed in will close down on the wire ends 434. This device allows the invention to be able to dynamically lengthen or shorten the distance between the support plates 404 and 401 therefore allowing the effective drop distance of the mount and the height position of an article to be dynamically modified.

In FIG. 29 three more wire clasping devices 435 are shown which provide an added level of security for the suspension. When tightened to the centre of the threaded wire for each plane fine adjustment is still provided, but with the added security that any failure of the wire suspension will result in the continuous wire pulling through to only the next adjacent eyelet.

In the preferred embodiment there are two mounting holes 409 as shown in FIG. 38 in the top plate 401 and a single mounting hole 408 in the bottom plate 404. A projector universal mount or projector mounting plate is then fastened to the bottom plate 404 via a wing nut 406 and washer 407 or other nut type fastener. The top plate 401 is fastened to a ceiling.

FIG. 31 shows an alternative embodiment in which the bottom plate 404 has the interface eyelets 411 replaced by a “U” shaped bracket eyelet 440. The continuous wire 403 is wrapped around the vertical eyelet bracket 440 in the manner shown in FIG. 31.

In FIG. 45 an alternative embodiment in which the top plate 441 is a factor of times bigger than the bottom plate 404. Therefore increasing the angle of the deployment of the flexible suspension lines as shown in FIG. 29. The length of the drop of the bottom plate 404 can be increase significantly and still maintain stable suspension. Also a cable management hole 442 can be included which facilitates the passing of projector power and signal cables to the projector. Also cables can be passed down any of the suspension lines formed from the continuous wire 403.

In FIG. 35 an alternative embodiment there is no top plate 401 as described in FIG. 29. There are four fixing fasteners 447 composed of vertical eyelets 443 incorporating fixing threads or screws 444. The eyelet 443 has a slot 445 used for the insertion of the continuous wire. Alternatively it could be freely rotating allowing the screws 444 to be inserted without winding of the continuous suspension wire 403. The continuous wire 403 is usually looped 446 around the vertical eyelet 443.

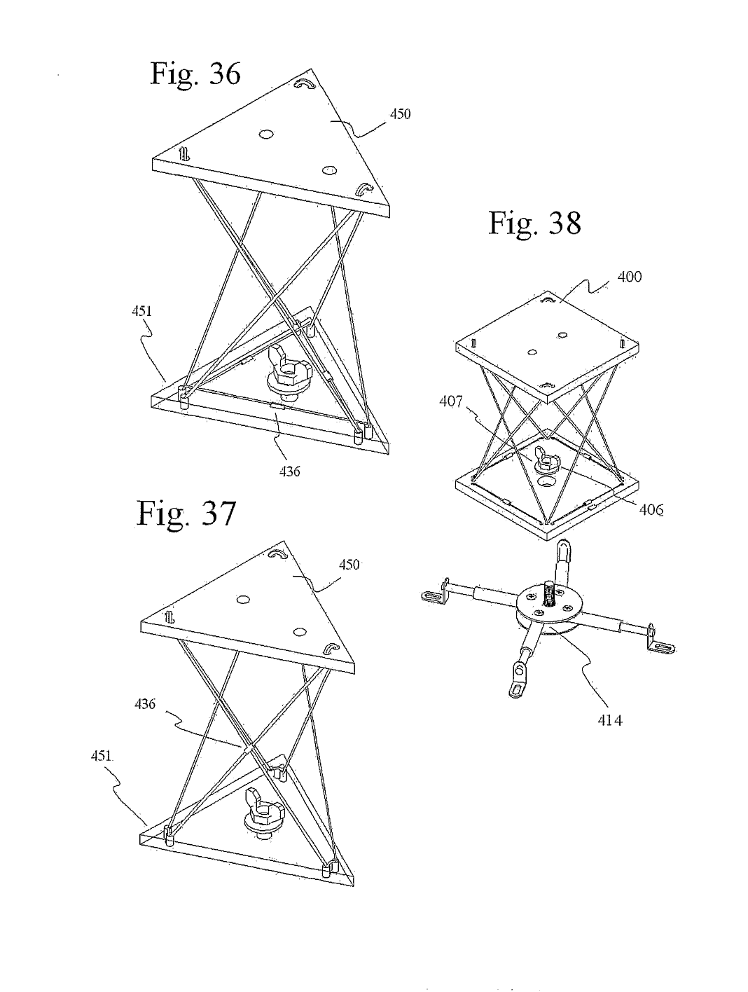

In FIGS. 36 and 37 alternative embodiments of the adjustable suspension mount are shown with a triangular configuration. Triangular top plate 450 and triangular bottom plates 451.

1. A projection system comprising: a screen and a projector spaced from the screen to project an image onto the screen, the screen and projector being suspended respectively from housings located in or on the ceiling or a wall of the room; each housing supporting an axially extending rod that supports a plurality of flexible suspension lines that are connected to an upper surface of the screen or a mount for a projector; and means to rotate each rod whereby the screen and projector can be lowered into an operative position or the lines can be wound onto the rods to lift the screen or projector into a stored position.

2. A suspension system for a projector or a screen comprising: a plurality of flexible suspension lines connected between an axially rotatable support and part of the frame of the projector or screen; the lines being spaced apart to provide hanging support for the screen or projector at spaced positions on the screen or projector; and means to axially rotate the support to cause the lines to wind or unwind on the support thereby either raising or lowering of the screen or projector.

3. A suspension system according to claim 2, wherein the support is of square or circular cross section and is self driven.

4. A suspension system according to claim 2, wherein a separate drive means is used to drive the support.

5. A suspension system according to claim 2, wherein the support and drive means are part of a tubular motor.

6. A suspension system according to claim 2, wherein the suspension system is secured to the ceiling of a room, wall or housed within an aperture in the ceiling.

7. A suspension system according to claim 6, wherein the aperture in the ceiling is closed off by a flap means.

8. A system for raising or lowering an article, comprising: support means positioned in an overhead position above the article; an arrangement of a plurality of flexible suspension lines interconnecting the article with a support means, the arrangement being such that when the article is in the suspended position the arrangement resists lateral deflection of the article; and means to rotate the support means to cause the lines to wind onto or off the support means to effect raising and lowering of the article.

9. The system according to claim 8, wherein the support means and means of rotation comprise a tubular motor.

10. A masking system for a projected image comprising: a plurality of masking panels of light absorbing material adapted to be removably placed around a perimeter of the image, each panel including means to facilitate removable attachment of the panel to the substrate on which the image is projected.

11. The masking system according to claim 10, wherein the means to facilitate removable attachment of the panel to the substrate comprises a magnetic attachment between the panel and the substrate.

12. The masking system according to claim 11, wherein each panel is magnetically secured to the substrate.

13. The masking system according to claim 12, wherein either the panel or the substrate respectively carry a magnetic strip or ferrous material and an appropriately positioned ferrous strip or ferrous material to facilitate magnetic attachment.

14. The masking system according to any one of claims 10 to 13, wherein the substrate is a screen or a flat surface such as a wall.

15. The masking system according to claim 14, wherein when the substrate is a screen the magnetic strip or ferrous strip may be positioned on either side of the surface of the screen.

16. The masking system according to claim 10, wherein each panel is removably attached to the screen through use of static electricity.

17. The masking system according to any one of claims 10 to 16, wherein the light absorbing material of the panel is a black fabric, black felt, velvet, paper or paint.

18. A universal mount for use in suspending a projector from the ceiling, comprising: a central hub having radially extending arms of adjustable length, the end of each arm being adapted to be attached to the projector; the hub having a central spigot adapted to be attached to a suspension rod arranged to be secured to the ceiling.

19. The universal mount according to claim 18, wherein the central hub comprises a pair of spaced plates, the arms comprising rods threaded at one end and hollow sleeves having a holding means at one end, wherein the other end of each sleeve is adapted to be bolted to the central hub to extend radially there from, and the length of the arms is adjustable by adjusting the holding means.

20. The universal mount according to claim 19 wherein the holding means is a grub screw that is tightened and loosened to allow adjustment of the arm lengths.

21. The universal mount according to claim 18, wherein the central hub comprises a pair of spaced plates and the arms comprise rods threaded at opposite ends and internally threaded hollow sleeves, one end of each sleeve being adapted to be bolted to the central hub to extend radially therefrom, the length of the arms being adjustable by screwing the rods into the sleeves.

22. The universal mount according to any one of claims 18 to 21, wherein the ends of the arms support attachment brackets adapted to facilitate attachment of the brackets to the projector.

23. The universal mount according to any one of claims 18 to 22, wherein a hollow sleeve surrounds the suspension rod and spigot of the universal mount, the sleeve being arranged to accommodate cabling that extends from the ceiling down through the suspension rod to the projector.

24. A projector mount assembly comprising a top plate and a bottom mounting plate adapted to be attached to a projector, each plate having a plurality of eyelet holes spaced around the periphery and a continuous length of flexible cord or wire threaded sequentially through the eyelet holes with the ends of the cord or wire secured together so that the mounting plate is suspended from the top plate.

25. The projector mount assembly according to claim 24, wherein adjustment means is attached to the ends of the cord or wire to alter the length of the cord or wire to vary the height of suspension.

26. The projector mount assembly according to claim 25, wherein the adjustment means comprises a sleeve positioned on the ends of the cord or wire, the sleeve having adjustable fasteners extending into the sleeve to engage the cord or wire.

27. The projector mount assembly according to claim 26, wherein a plurality of sleeves are secured to the cord or wire to facilitate micro adjustment of the cord or wire, the sleeves being incapable of passing through the eyelet holes.

28. The projector mount assembly according to any one of claims 24 to 27, wherein the top plate is of greater cross section than the mounting plate.
